(19) United States
(12) Patent Application Publication
(10) Pub. No.: US 2006/0265396 A1
(43) Pub. Date: Nov. 23, 2006

(54) Personalizable information networks

(75) Inventors: Suri Raman, Mercer Island, WA (US); Matthew F. Hillman, Seattle, WA (US); Ashwani Sirohi, Issaquah, WA (US)

Correspondence Address: PERKINS COIE LLP;PATENT-SEA, P.O. BOX 1247, SEATTLE, WA, 98111-1247, US

(73) Assignee: Trimergent

(21) Appl. No.: 11/334,008

(22) Filed: Jan. 17, 2006

Related U.S. Application Data
(60) Provisional application No. 60/683,282, filed on May 19, 2005.
(60) Provisional application No. 60/711,580, filed on Aug. 25, 2005.

(51) Int. Cl. G06F 17/30

(52) U.S. Cl. 707/10

(57) ABSTRACT

A facility for creating a shareable pinboard collection is disclosed. In various embodiments, the facility receives from a user a selection of one or more search providers, employs the selected one or more search providers to perform a search for information items matching a criteria specified by the user, and receives an indication of information items located by the selected one or more search providers.

### CROSS-REFERENCES TO RELATED APPLICATIONS

This application claims the benefit of U.S. Provisional Patent Application Ser. No. 60/683,282, filed on May 19, 2005, and U.S. Provisional Patent Application Ser. No. 60/711,580, filed on Aug. 25, 2005, which are both incorporated herein in their entireties by reference. This application is related to the following U.S. utility patent applications that are filed concurrently herewith and incorporated herein in their entireties by reference:

| Patent | | |
|---|---|---|
| Application | | Attorney |
| Ser. No. | Title | Docket No. |
| | Personalizable Information Networks | 57372-8001US2 |
| | Personalizable Information Networks | 57372-8002US |
| | Personalizable Information Networks | 57372-8003US |

### BACKGROUND

Users of computing devices can employ their computing devices to communicate information to other users in many ways. Two ways of communicating information that are commonly found in many business organizations can be categorized as “messaging” or “hosted” models.

In the messaging model, users employ a messaging infrastructure to send information to other users. Messaging infrastructures include electronic mail (“e-mail”), instant messaging, and so forth. While users generally find the messaging model to be easy to use, this model has various deficiencies, some of which are identified herein. One deficiency is that users generally send a “snapshot” of information to other users. As a result, different users may receive different versions of the information. As an example, if a user sends information via an e-mail attachment to a group of users and another user in the group modifies the information and forwards the modified information to the group, other users of the group can receive two versions of the information. When multiple users modify the information and send the modified information to the group, users may be confused as to which modifications are the most recent. This deficiency may be further exacerbated when e-mails contain attached documents, which leads to version detection problems. A second deficiency with the messaging model is that access cannot generally be controlled. In particular, it is very difficult for an originator of information to control which users have access to the information. As an example, although an originator of information may select an authorized set of recipients, the originator cannot control what the recipients can do with the information. Thus, a recipient can forward the information to an unauthorized user. E-mail also has other deficiencies, such as those listed here: without complex rules or programming, it can be difficult to organize the e-mail inbox; a copy of an e-mail message can generally be filed in only one folder; sharing an e-mail threaded discussion with a person who becomes involved in a project late can be difficult; adding a new user to a threaded discussion having multiple forks generally does not give a comprehensive picture of the thread to the new user; and e-mail messages can have embedded attachments, and providing inline contextual comments relating to attachments is problematic.

In the hosted model, users place information at a commonly referenced location. As an example, the hosted model includes file servers, web servers, electronic bulletin boards, content management solutions, workspaces, and so forth. Another example of the hosted model is a “portal,” which business organizations sometimes build to publish information. A portal is generally a website built on a common set of application services that enables business organizations to publish information to users. Users generally view information contained in portals by utilizing an Internet browser or other application that is capable of showing information contained in the portal. Advantages of the hosted model are that users will see the latest hosted information and the information is usually organized. However, there are several deficiencies in the hosted model, some of which are identified herein. One deficiency is that the hosted model generally requires some centralized administration to update the information or to organize the information. A second deficiency is that users cannot easily control which other users have access to information because administrators generally control access privileges to portal document locations rather than users. A specific deficiency of portals is that they are generally complicated and labor-intensive to create and maintain. Portals also have other deficiencies, such as those listed here: portals generally become “stale” unless the information is reloaded and updated; generally, most information is authored using authoring tools (such as MICROSOFT WORD), approved via an approval process (e.g., e-mail), and then uploaded to the portal; even without approval workflow, the separate acts of authoring and then uploading often makes information on the portal stale; portals often require upfront organization and taxonomy decisions to define a structure and are not easy to alter once the structure has been created; discovery of information across portals is through “federated” or other searches, which simply provide search results that a user has to navigate one by one; and portals require users to identify a location (e.g., intranet or Internet URL).

An attempt to resolve deficiencies and take advantage of benefits of both models is the use of the hosted model in combination with the messaging model, wherein an e-mail is sent to users containing an indication of hosted information, such as a pointer or a link to a location where the information is stored. While this approach enables users to see the latest version of organized information, it also has multiple deficiencies, some of which are identified herein. One deficiency is that access control is uncoordinated. While a user can specify which other users will receive an e-mail containing the links, the user cannot easily specify access control attributes such as whether the recipients of the links can view the information or whether the recipients can forward the links to other users. A second deficiency is that users cannot easily search for information in their inbox because only links appear in their e-mail.

### BRIEF DESCRIPTION OF THE DRAWINGS

FIGS. 1-3 are display diagrams illustrating display results pages provided by the facility in various embodiments.

FIG. 4 is a flow diagram illustrating a collect_information_items routine that is employed by the facility in various embodiments for collecting information items.

FIG. 5 is a flow diagram illustrating a handle_URL routine that is employed by the facility in various embodiments for handling uniform resource locators identifying pinboard collections.

FIG. 6 is a flow diagram illustrating a create_pinboard_collection routine that is employed by the facility in various embodiments for creating a pinboard collection.

FIG. 7 is a table diagram illustrating a result set table created by the facility when executing a query plan in various embodiments.

FIG. 8 is a block diagram illustrating a suitable environment in which the facility may operate in various embodiments.

FIG. 9 is a block diagram illustrating aspects of a server of FIG. 8 in further detail in various embodiments.

FIG. 10 is a display diagram illustrating a display results page provided by the facility in various embodiments.

FIG. 11 is a display diagram illustrating a user interface for indicating permissions employed by the facility in various embodiments.

FIGS. 12A-12E are block diagrams illustrating relationships between pinboard collections and information items for determining permissions in various embodiments.

FIGS. 13A-13C are flow diagrams illustrating routines that are employed by the facility in various embodiments for modifying access control permissions.

FIG. 14 is a flow diagram illustrating a monitor_changes routine that is employed by the facility in various embodiments for monitoring changes to information items.

FIG. 15 is a flow diagram illustrating a replicate routine that is employed by the facility in various embodiments for replicating changes.

FIG. 16 is a block diagram illustrating components for and aspects of the facility's use of multiple search providers.

FIG. 17 is a block diagram illustrating various components employed by the facility.

### DETAILED DESCRIPTION

A software facility for personalizable information networks (“the facility”) is described. A personalizable information network (“PIN”) comprises one or more collections. A collection comprises references (e.g., links to documents) or information items that are aggregated from various networked locations to enable a user to locate and retrieve information items without necessarily knowing where the information items are stored. An information item is a source of information, such as a document, web page, e-mail message, row or field in a database, etc., that can be uniquely identified, such as by using a uniform resource locator (URL). The information items can be stored in digital form in any place that is accessible by the facility, such as at a server, in an e-mail system, in a file folder, in a database, in a repository associated with a client or server computing device, and so forth. The URL identifying an information item can identify a portion or location within a document or web page. In various embodiments, the facility provides latest versions of information items to users in an organized manner. Using the facility, a user (a “creator”) can aggregate information from disparate storage media, identify other users (“recipients”) for distribution of the aggregated information, and share the aggregated information with the recipients. Storage media can include, e.g., any networked device including server or client computing devices, such as e-mail storages, file systems, Internet, instant messaging, databases, etc. The creator can control access to the information and actions the recipients can take on the information. The information can be organized or reorganized by the creator, recipient, or another user. A creator can share information with multiple recipients, specify a list of recipients to whom the information should be distributed, and set access control attributes (e.g., permissions or privileges) associated with either the shared information or the recipients. If the creator has provided sufficient permissions to recipients, the recipients can view, append, modify or take other actions relating to the aggregated information. The facility thus creates a personalizable network of information.

The facility enables a user to specify search criteria to identify a potential set of information items and construct a collection of information items that the user desires to share. The collection can include additional information items that were not identified by the search. Upon receiving an indication of search criteria from the user, the facility utilizes search providers to locate information items matching the search criteria from multiple sources of data. The facility performs a “meta-search” across multiple “search providers.” A meta-search is a search that can be performed across various information repositories and sources, after which found information may be provided together in a common format. A search provider is a service that performs a search using one or more information repositories. As an example, the facility could use GOOGLE SEARCH, MICROSOFT SEARCH, or any provider of search technology or combination thereof. As a further example, a user can configure the facility to use GOOGLE Internet search and MICROSOFT desktop search. As another example, the facility can use search providers that locate information in various data sources, such as Internet (or other) news feeds, web logs (“blogs”), databases, computer file systems, document management systems, and so forth. The information items can be located in computing or storage devices connected to the Internet, an intranet, or any location that the search providers can access, such as e-mail servers, client computing devices, etc. The facility can also employ search providers that search various data types. The search providers may provide results in a “unified” view such that the facility or other applications do not need to function with multiple results formats. The search providers can be located anywhere in association with a computing device, such as in storage as an executable file, in an e-mail message as an attachment, or in the Internet. The facility can locate and employ the search providers automatically or under user direction. In some embodiments, search providers are identified by a URL. As an example, the facility can employ the search provider identified by the URL to retrieve information based on a query provided with the URL.

Once the facility locates relevant information items, the facility processes the located information items using a processing engine. The processing engine creates “extracts” of the located information items. An extract is a portion of an information item. As examples, an extract can include an information item's title, description, and schema-specific properties such as e-mail sender, time of receipt, telephone numbers of contacts, and so forth. The extracts are stored using a schema that is appropriate for various types of information items. As an example, the processing engine may create an extract in a document schema for information contained in a MICROSOFT WORD document, but may create an extract in a database schema for information contained in a database. The facility may employ similar schemas for various types of documents. The extract may be defined with reference to a standard document definition format, such as Rich Site Summary or Really Simple Syndication (commonly referred to as “RSS”) or generally recognized alternatives to RSS, such as ATOM or Outline Processor Markup Language. In various embodiments, the schema is specified in an extensible markup language (“XML”). As an example, the facility may employ RSS to define document extracts and a different XML schema to define database extracts. An extract provides attributes from information items that are identified to be relevant. As an example, an extract schema for an e-mail information item may indicate that the sender's name, recipient's name, and subject attributes are relevant. As another example, a contact extract schema may indicate that name, telephone number, and e-mail attributes are relevant. When the facility employs extracts to display information from information items, the facility may display the relevant information. Thus, extracts enable the facility to generate rich user interfaces based on unique information item types.

Whenever the facility displays information relating to an information item in a display results page, it may utilize information from the information item. When the user loads an information item, such as by selecting a link, the facility loads the information item either from the original location or a cache storage. The facility combines information items to create a pinboard collection. A pinboard collection comprises information items and can be accessed via a URL. When the pinboard collection is accessed via the URL, the facility transforms pinboard collections using a view description into a display results page. A view description provides instructions on how to transform pinboard collections into display results pages that may be readable by a human. As examples, the view description can be specified using an extensible style sheet language (“XSL”), active script pages (“ASP”), etc. Display results pages provide identifying data about each information item along with some data relevant to the information item. As an example, display results pages may provide links, titles of documents, the first few lines of the text contained in the document, a date the document was created, and so forth. Display results pages may also provide annotations relating to the document that are added by creators or recipients. An annotation is information that a user associates with an information item. Examples of annotations include text, formatting, and multimedia, such as textual comments, highlighting, and voice (or video) comments. Annotations can be short (e.g., words or phrases) or long (e.g., sentences, paragraphs, or whole documents or identifiers of other information items). When the facility shares or otherwise utilizes information contained in display results pages, the facility may employ or manipulate the underlying pinboard collections, which may be stored in an RSS or other format.

Upon creating a display results page, the creator can then identify a subset of the information items indicated by the search providers in response to the query. As an example, if the facility identifies several information items, the creator can identify a subset of information items that are truly relevant and remove (or otherwise identify) the remaining information items that may be irrelevant. The creator can also reorganize the display results pages and thereby cause the facility to reorganize the underlying pinboard collection, such as to reorder the displayed information so that an important information item appears before a less important information item. The creator can perform multiple searches and continue to add information items to the pinboard collection.

The creator can then identify recipients with whom the creator desires to share the created display results pages. The creator can identify recipients in a manner similar to selecting recipients for e-mail. As an example, the creator can identify recipients or groups of recipients from an address book, type in a portion of a recipient's name or identifier and request the facility to “resolve” the recipient's name or identifier, e.g., by completing the identification of the recipient, and so forth.

Creators can also add or modify various attributes of the pinboard collection. As an example, creators can add annotations, such as messages, relating to individual information items or the pinboard collection as a whole. As another example, creators can indicate information items of particular interest, such as by highlighting an information item or by rating the information item on some scale, such as by using a “thumbs up” metaphor. As other examples, creators can “lock” a particular version of the information item being shared so that future changes are not shared; creators can indicate various access methods on an item, e.g., cannot share further with other users, can share further freely, can modify the original information item; etc.

Once the creator shares the pinboard collection with recipients, such as by selecting a “share” button on the display results pages' user interface, recipients can view the information items identified in the pinboard collection according to the recipients' access privileges. An access privilege specifies what actions a recipient can perform in relation to an information item or a pinboard collection, such as view, edit, delete, share, and so forth. The facility provides recipients with an appropriate access privilege, as is described in further detail below.

Recipients can respond to a received pinboard collection and share their responses with the creator or other recipients. Recipients can add or modify various attributes of the received pinboard collection before sharing their responses. As an example, recipients can add annotations. When a creator provides sufficient access privileges, recipients can share the received pinboard collection. Recipients can also perform searches and add found information items to the pinboard collection. The creator can accept or reject additions, deletions, or modifications made by recipients, either automatically or manually.

When a creator or recipient modifies a pinboard collection, users may see the latest modified version. This is possible because a display results page is generated at the time a viewer (e.g., a recipient) loads the display results page for viewing. References and other information contained in pinboard collections can be modified by creators and recipients (when the recipients have sufficient access privileges). When a user loads a display results page, the facility provides the most up-to-date version of the display results page. Users thus do not need to know whether they are sharing or viewing the most up-to-date version of a document.

A user can “lock” a pinboard collection or one or more information items. When an item (e.g., pinboard collection or information item) is locked, users who view the locked item do not see any updates made after the locking. To accomplish this, the facility uses a stored version of information items. When a user locks an item, the user is able to continue updating the item. Then, when the user unlocks the item, the user's updates are visible to all other users. The facility may create an audit trail of locks and updates.

Creators or recipients can refine the search by iteratively adding search terms. The resulting pinboard collection contains information items in one place representing information from multiple data sources or data types.

While the facility is described herein with reference to pinboard collections and information items, the facility provides a platform that is readily adaptable to various other environments and applications, some of which are described herein.

The features of the facility will now be described in further detail.

Creating and Using Personalizable Information Networks

In various embodiments, a user interface provided by the facility contains a text box and a “search” button. A user can provide a query in the text box, such as by typing a string, and select a search button that causes the facility to begin searching for information items (e.g., documents) matching the query.

In various embodiments, the facility can synchronously or asynchronously use multiple search providers simultaneously or concurrently to locate information items. As an example, the facility can search using GOOGLE Internet search, MICROSOFT desktop search, a portal search facility, a WINDOWS desktop search facility, a network search facility, a database search facility, a federated search facility, any Internet search facility, and so forth. In various embodiments, the facility has an extensibility mechanism that enables users to add third-party search providers. By enabling the addition of search providers, the facility is capable of searching for information items stored in any form and in any location. Each of the invoked search providers returns results of the search to the facility.

The creator can specify which of several search providers to use, such as by activating some or all of the search providers. When the facility searches, the facility may not invoke the inactive search providers. A creator can activate a search provider for a pinboard collection and inactivate that search provider for another pinboard collection. Thereafter, the facility may only use the active search providers for each of the pinboard collections. The creator can also associate a default list of search providers (e.g., by “pinning” the search providers with a pinboard collection. The creator can also discover and enable other search providers from a pinboard collection for any new query on that pinboard collection. Optionally, the set of search providers used can be stored by pinning them to a pinboard collection. Search providers can also be disabled for a particular query.

The facility initially organizes the results of the search in a display results page according to a default layout. A layout indicates presentation attributes, such as fonts, colors, locations, background, etc. A user can modify the default layout. In various embodiments, the default layout is specified in XML.

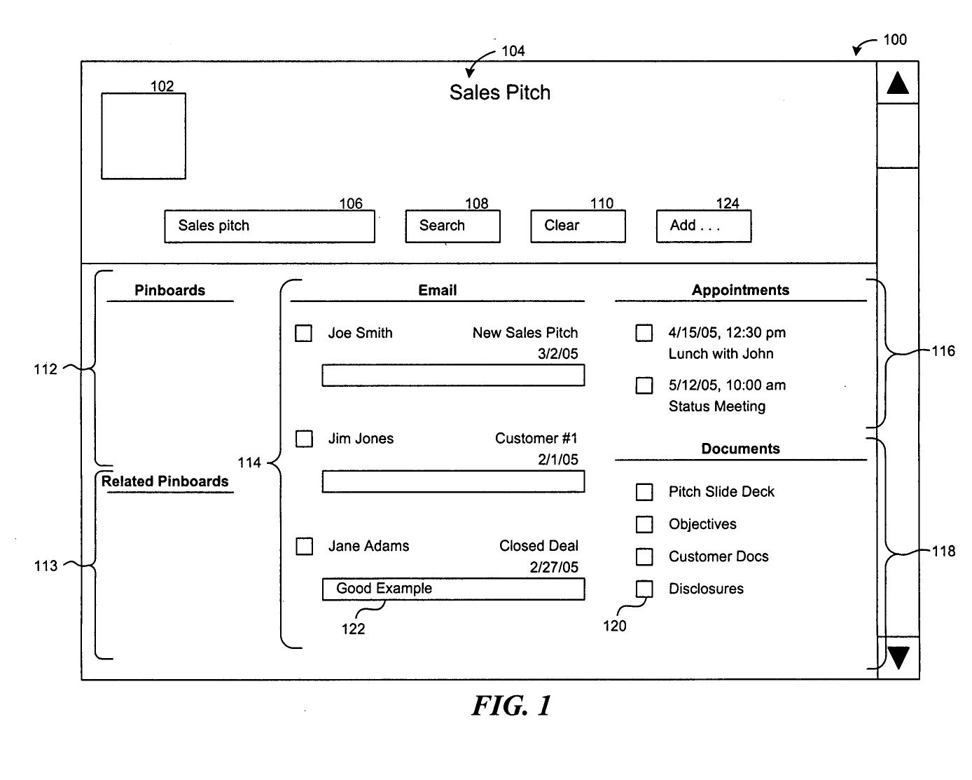

Turning now to the figures, FIG. 1 is a display diagram illustrating a display results page provided by the facility in various embodiments. The facility provides the display results page 100 that a creator can use to create a pinboard collection. The display results page includes an area 102 for an image, such as a logo, and an area 104 for indicating a title of a resulting pinboard collection. The display results page includes a text region 106 within which the creator can enter a search query. The creator can then select a search button 108 to begin the search. Alternatively, the creator can select a clear button 110 to clear all the information added by search providers to the display results page.

The illustrated display diagram illustrates that the creator has entered “Sales pitch” as the query in text region 106. Upon clicking the search button 108, the facility locates information items matching the query “Sales pitch” and populates various results regions of the search page with results of the search. The illustrated display results page shows a pinboard collections results region 112, a related pinboards results region 113, an e-mail results region 114, an appointments results region 116, and a documents results region 118.

The pinboard collections results region 112 lists pinboard collections that match the query. In the illustration, no pinboard collections match the query and so no pinboard collections are listed. Pinboard collections may match the query when the query of the display results page provides information items that are pinned to other pinboard collections. Furthermore, the facility may list other pinboard collections to which an information item indicated in one of the results regions may be pinned. This enables a user to quickly determine content and relevance for an information item.

The related pinboards results region 113 lists pinboard collections that are related to the displayed pinboard collection. Two pinboards may be related because, e.g., one was created in response to another, they both reference the same information items, they are indicated by a user to be related, or one of the pinboard collections is pinned to the other.

The e-mail results region 114 lists e-mail messages that match the query. An e-mail message may match the query when the e-mail message contains text or other attributes matching the query. The e-mail results region may display various attributes relating to e-mail messages that match the query, such as sender, subject, and date or time sent.

The appointments results region 116 lists appointments that match the query. The documents results region 118 lists documents that match the query. In various embodiments, the facility may display other results regions instead of, or in addition to, the illustrated results regions.

Each information item listed in the results regions is accompanied by a selection indicator, such as a checkbox 120. The creator can select a subset of the information items listed in the results regions to add to the pinboard collection, such as by selecting the checkbox associated with each information item the creator desires to retain in the pinboard collection. This action can be referred to as “pinning.” Thus, the facility enables a user to add a search result to a document using a single action, such as by selecting a checkbox. The checkboxes may not appear when the user is not in an authoring mode.

Each information item listed in the results regions may also be accompanied by a text region, such as a text region 122. The creator can add an annotation relating to an information item in the text region. As an example, the creator has added the annotation “Good example” in the text region associated with an e-mail relating to a closed deal in the illustration.

In various embodiments, the facility utilizes the extracts (e.g., data contained in the extracts' schema) to populate the results regions. As an example, the facility may employ e-mail extracts to populate the e-mail results region.

The display results page or other user interface elements of an application additionally may provide an option for the creator to add additional information items that were not found with the query. As an example, the search page may provide an add button 124. By selecting the add button, the creator can specify additional information items in a similar manner to adding attachments to an e-mail message. The facility also provides an application program interface (API) for pinning information items identified by an application to a pinboard collection. Using this API, other applications (e.g., MICROSOFT WORD) can implement user interfaces to directly pin their native documents to a pinboard collection. As an example, a toolbar in MICROSOFT WORD could have a “Pin” button and a drop-down list which lists pinboard collections for which the user has modify permission that the document can be pinned to. Selecting this button would pin the active MICROSOFT WORD document to the selected pinboard. As a further example, a user can select an information item and pin that information item to another pinboard collection.

In various embodiments, the facility provides an authoring mode for pinboard collections. When a display results page is in editing mode, users may be able to add annotations, pin search items, and so forth. When the facility exits editing mode, such as when the creator shares the pinboard collection, the user may no longer be able to annotate or pin information items. In various embodiments, some editing functions may be available after exiting the authoring mode.

In various embodiments, the facility enables a recipient to search within information items associated with a pinboard collection in addition to using other search providers. As an example, suppose a recipient receives a pinboard collection with the query “sales pitch.” The recipient can then search for “Jane” within the information items in that pinboard collection to locate information items associated with “Jane.” Information items found as a result of this additional search may be grouped together, whereas other information items appearing in the pinboard collection may be grouped separately.

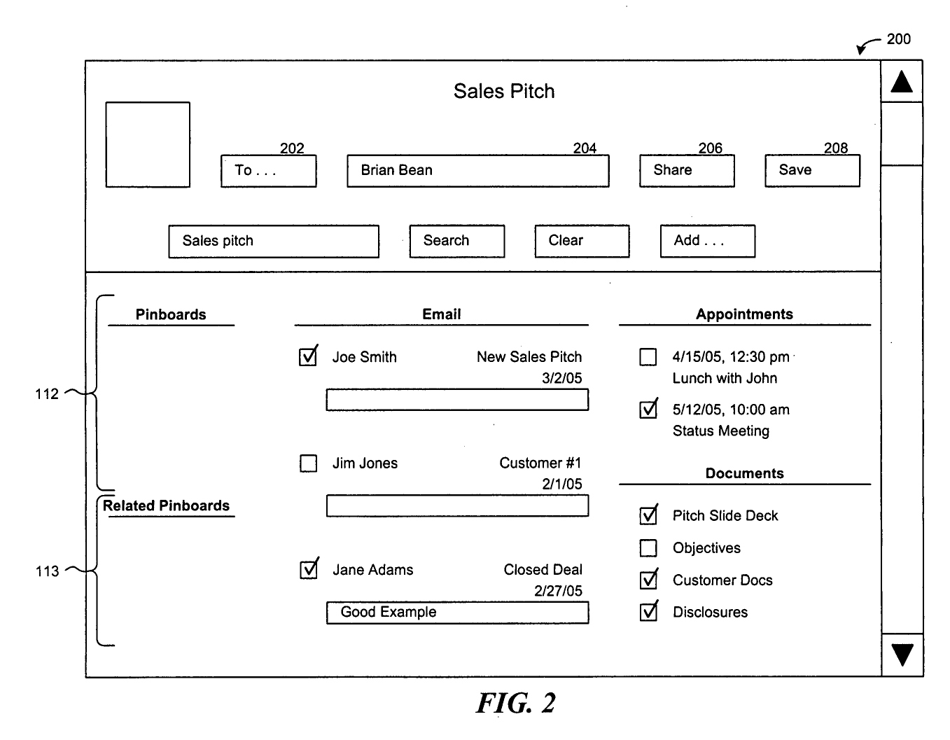

FIG. 2 is a display diagram illustrating a display results page provided by the facility in various embodiments. This illustrated display results page 200 is similar to the display results page 100 illustrated in FIG. 1 except that it additionally has an address lookup button 202, an address text region 204, a share button 206, and a save button 208.

The address lookup button 202 may be selected by the creator to select a list of recipients for the created pinboard collection. As an example, the facility may use MICROSOFT ACTIVE DIRECTORY, a global address list corresponding to an e-mail server, a personal contacts list, or any directory of recipients. In various embodiments, the facility may provide a user interface for selecting recipients that includes an ability to indicate access privileges relating to the recipients. Access privileges are described in further detail below.

The facility may display a list of selected recipients in the address text region 204. The facility may also receive a list of recipients from the user using the address text region. In the illustration, Brian Bean is selected as a recipient.

The creator may select the share button 206 to share the created pinboard collection with the indicated recipients. The creator may select the save button 208 to save the pinboard collection rather than share it with recipients.

In various embodiments, the facility may add the user interface elements described above in relation to FIG. 2 when the creator has selected some information items, such as by selecting checkboxes 120. In other embodiments, the facility may provide these user interface elements when displaying the search page 100. In yet other embodiments, the facility may provide these user interface elements when requested by the creator, such as in response to an action appearing in a menu.

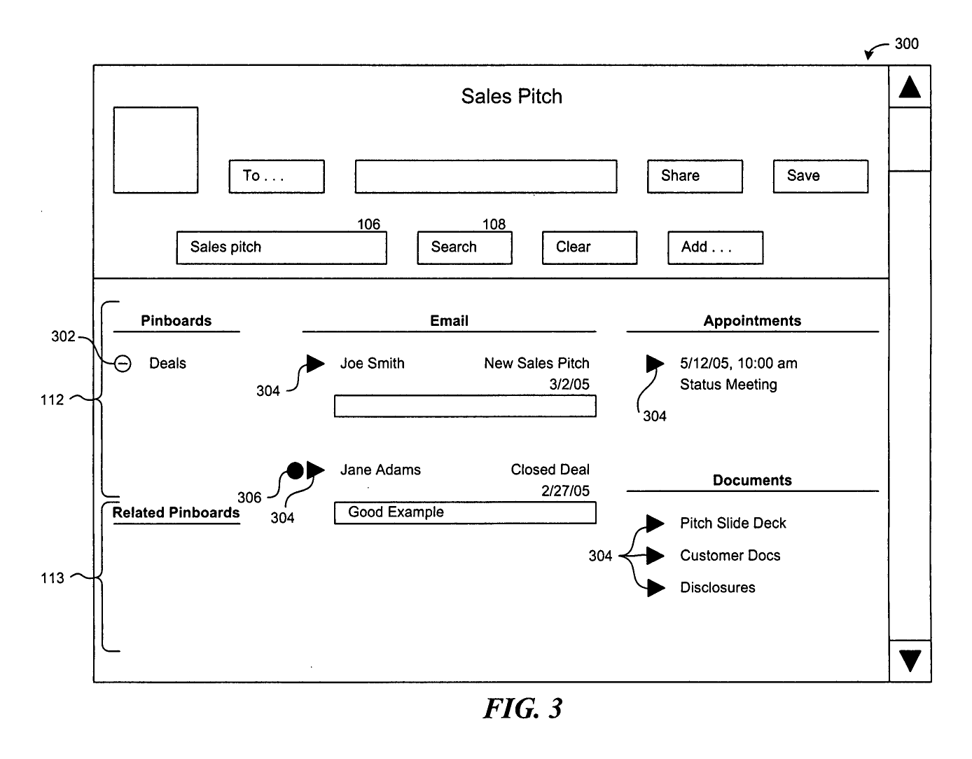

FIG. 3 is a display diagram illustrating a display results page provided by the facility in various embodiments. This display diagram illustrates a display results page 300 that was shared by its creator and received by recipients selected by the creator (e.g., Brian Bean). The illustrated display results page is similar to the display results page 200 illustrated in FIG. 2 except that it lacks some of the results appearing in the display results page 200 and additionally indicates a pinboard collection result 302, pin indicators 304, and secondary pinboard collections indicators 306. The illustrated display results page is not in authoring mode, as is indicated by the absence of authoring features, such as the checkboxes. In various embodiments, other features may be added or removed. As an example, in various embodiments, the “To . . . ” button, the “Share . . . ” button, and the “Save . . . ” button may be removed.

The illustrated display results page does not display information items that were not pinned by the creator by selecting checkboxes. As an example, an e-mail from Jim Jones was not selected by the creator and so does not appear in the display results page. Similarly, the “Lunch with John” appointment and “Objectives” document do not appear in the display results page.

The illustrated pinboard collections results region 112 contains the pinboard collection result 302. In various embodiments, additional pinboard collections results are listed when the facility determines that information items listed in a previously stored or received pinboard collection would also be appropriate for the query of the pinboard collection associated with the displayed display results page. Additionally, as previously stated above in relation to FIG. 1, the display results page could list pinboard collections if they relate to the query, and these pinboard collections would also appear in the pinboard collections results if selected by the creator. Thus, the facility enables pinboard collections to be combined or “nested.”

The pin indicators 304 provide an indication to recipients of information items selected by the creator (e.g., “pinned”) when creating the pinboard collection. Because the pinboard collection is created dynamically, additional information items may appear in the display results page, but these would not have an associated pin indicator. Thus, a recipient or creator is immediately able to distinguish pinned information items from other information items added dynamically by the facility, thereby enabling users to quickly determine which information items could be more relevant or which information items are “new.” In various embodiments, the facility groups pinned information items together and other information items in another group. Thus, a single pinboard collection can be used to combine a filtered set of information items with additional information items that match the query of the pinboard collection. Furthermore, multiple search providers (including the original pinboard collection itself) may provide information relating to an item search. This information can be condensed into a single information item for display in the pinboard collection without any duplicate information. For example, one search provider may provide a title and description for an item, whereas another search provider may supply a specific user's annotation. The displayed information item would indicate the title, description, and annotation. Thus, the facility provides a feature in which an information item comprises information from multiple sources. The facility can create an “overlay” by querying the information items, preserving unique attributes, and removing duplicated attributes.

The secondary pinboard collection indicator 306 indicates information items that are associated with pinboard collections listed in the pinboard collections results region. When the user selects the pinboard collections result, the facility toggles the corresponding pinboard collection indicators. In some embodiments, when the user selects the pinboard collections result, the facility causes information items associated with the selected pinboard collections result to be displayed in the results region. As an example, a “Deals” pinboard collections result appears in the pinboard collections results region shown in the illustrated embodiment. The symbol to the left of the Deals pinboard collections result (a minus symbol enclosed by a circle in this embodiment) indicates that information items associated with the pinboard collections result are indicated with a secondary pinboard collection indicator. As an example, the e-mail from Jane Adams is associated with a secondary pinboard collection indicator. When the user selects this pinboard collections result, a different symbol may appear to the left of the pinboard collections result. As an example, in the illustrated embodiment, a plus symbol may appear. When the pinboard collections result is toggled, the facility may remove secondary pinboard collection indicators. As an example, the facility may remove the secondary pinboard collection indicator associated with the e-mail from Jane Adams. In various embodiments, the text region 106 and search button 108 appear within the document's canvas (e.g., in the same window pane as the search result).

In various embodiments, the pinboard collection may additionally display other information items. As an example, the pinboard collection may display items that were added by the creator or by another recipient. The user may be able to temporarily remove such items from display, such as by “collapsing” a region. A user can collapse a region by, e.g., selecting a minimize or hide button (not shown).

Thus, search results are displayed “in context,” meaning that the user does not need to open another application or window to add search entries to a document, such as a pinboard collection.

When a creator shares a pinboard collection with a recipient, the recipient may receive a notification of the pinboard collection. As an example, the recipient may receive an indication of the shared pinboard collection via e-mail. The e-mail may contain a link or a URL corresponding to the pinboard collection. When the recipient selects the link, the facility displays the shared display results page corresponding to the pinboard collection, such as in an Internet browser. The displayed display results page includes all information items that were pinned by the creator. The displayed display results page may also provide an indication of all recipients with whom the creator shared the pinboard collection.

Display results pages are populated dynamically when they are displayed by using an associated pinboard collection. Thus, even after a creator creates a pinboard collection, the creator's (or recipient's) updates to the pinboard collection are always available to recipients. As a result, a creator can add, remove, or modify information items associated with a pinboard collection that has been shared with recipients.

A recipient may be able to share a received pinboard collection with other recipients. Whether a recipient is capable of sharing the display results page with others is controlled by the creator, as is described in further detail below. When the recipient shares the pinboard collection with others, the facility does not duplicate the display results page or its contents for the other users, unlike conventional e-mail systems. Instead, a display results page is recreated dynamically when a downstream recipient opens the display results page.

When the recipient selects a link associated with an information item appearing in a display results page, a software application associated with the selected information item is invoked. The software application then loads and displays the corresponding information item. As an example, when a spreadsheet is linked to a pinboard collection, a spreadsheet application opens the linked spreadsheet.

Controlling Access

Whether a recipient has access to an information item appearing in a pinboard collection depends on a number of factors. First, access to a pinboard collection may be controlled by the pinboard collection's creator. As previously stated, the creator of a pinboard collection can specify privileges associated with the pinboard collection. As an example, the creator can indicate that recipients of the pinboard collection can share the pinboard collection with other recipients. Alternatively, the creator can indicate that recipients cannot share the pinboard collection with others. When the creator of a pinboard collection has permitted recipients to share the pinboard collection, recipients who receive the pinboard collection from other recipients (“downstream recipients”) may only be able to view information items to which they have been provided access.

Second, a recipient may only be able to view information items to which the recipient has access via a file system, a database, or other data source associated with the facility. As an example, if a pinboard collection contains links to two information items and the recipient only has access to one of the information items because a network administrator has explicitly not provided access to the other information item, the recipient may be able to view only the information item to which the recipient has access. In general, however, the facility manages access control permissions.

Third, creators may also specify privileges associated with information items appearing in a pinboard collection. As an example, a creator may indicate that some information items appearing in a pinboard collection are not to be shared with other recipients. Then, when a recipient attempts to share the pinboard collection with other recipients, the facility would not share information items so indicated.

Pinboard collections that are listed in a pinboard collection (e.g., via pinning) may inherit or propagate these various privileges when the pinboard collection is shared. Thus, the creator has fine-grain control over access.

In various embodiments, the facility provides recipients with an ability to respond to a received pinboard collection by either (1) sharing a response with the creator (“private response”) or (2) sharing a response with all recipients with whom the creator shared the pinboard collection, including the creator (“public response”). When the recipient sends a public response, the response receives its privileges from the pinboard collection that the recipient responds to. As a result, when the creator adds recipients to the original pinboard collection, the added recipients get access to not only the original pinboard collection, but also all public responses. This inheritance may be limited by the creator's indications that a pinboard collection is not to be shared by recipients.

These public and private responses are themselves pinboard collections. They are distinguished by an attribute causing them to “inherit” access privileges from the pinboard collection they are responding to. A user can view all responses to a pinboard collection by viewing related pinboards results, such as those displayed in region 113. A user can view information items contained in a pinboard collection of a message response together with the original pinboard collection using the “overlay” feature described above.

A creator or recipient can relate pinboard collections by explicitly relating them or responding to the original pinboard collection. By explicitly relating pinboard collections, the facility enables conversation threading, which is described in further detail below. When a display results page is retrieved, the facility can display a list of related pinboard collections or responses. The facility may also process the related pinboard collections or responses, e.g., by overlaying nonduplicate information.

The creator or recipients with sufficient access control permissions can modify a shared pinboard collection, such as to add a recipient to a thread. When the added recipient views the thread, the added recipient is able to see all relevant information items and annotations. Thus, for example, the added recipient can be brought up to date on a thread quickly and easily. The added recipient will receive access to all relevant documents without any further intervention by an administrator. As an example, a new member of a project team can be quickly provided access to all of a project's documents and discussions in a secure and straightforward manner. The person sharing the pinboard collections with the newly added recipient would not have to search for the project's documents, request an administrator to change access control permissions, and so forth. By merely sharing the pinboard collection via a single action (e.g., selecting a share button), the sharing user can bring a newly added recipient up to date.

The facility can function with access control permissions relating to objects stored in a file system, database, or elsewhere. As an example, when an information item is retrieved from a database, the facility retrieves access control permissions from the database. When this information item is shared, the facility may update the access control permissions in the database. Thus, the facility provides row-level database access control permissions control in various embodiments.

Conversation Threading

The facility enables a superior model of conversation threading than conventional systems. Conversation threading is a way of associating an information item with other information items. In conventional systems, such as in an e-mail environment or electronic bulletin board, a message generally belongs to only one conversation (e.g., thread). Moreover, an entire conversation thread cannot be forwarded to a user because, for example, multiple people may respond to a particular response and these multiple responses would not all appear together in a single message. As a result, users may need to open each response one at a time to view the entire conversation.

The facility enables each pinboard collection to optionally contain multiple conversation threads. Each such conversation thread enables a pinboard collection to merge multiple sources of information in meaningful ways. As an example, a pinboard collection may contain multiple information items wherein each item is from a different information source. Each information item may have annotations relating to that information item. In some embodiments, a user can provide different annotations for an information item depending on in which pinboard collection the information item appears. When the pinboard collection is shared with a recipient, the recipient receives indications of all information items and annotations based on the recipient's permissions. The facility provides indications as notifications (e.g., via a messenger-like product, e-mail, etc.) or as items in a pinboard collection the recipient views. Thus recipients may be able to view all conversation threads associated with the shared pinboard collection. The facility uses various features, such as its overlay and calculation and application of access control permissions, to enable complex conversation threading.

The information items and annotations, retrieved from a pinboard collection and one or more overlaid or related pinboard collections, forms a threaded conversation. Furthermore, because access is controlled by the facility, a recipient can only see portions of the conversation to which the recipient has access. Because the facility queries all rows having the unique identifier, the facility can remove duplicate attribute entries and “overlay” the unique entries.

In another aspect of conversation threading, information items and annotations made thereto are selectively shared with recipients. As an example, suppose user W creates a pinboard collection, annotates some information items, and subsequently shares the created pinboard collection with users X and Y. Next, suppose user X adds a further annotation to the pinboard collection and shares the updated pinboard collection with user W in a private response. Suppose also that user Y adds a third annotation to the information item and shares this response with users X and W. When user W shares the pinboard collection with a fourth user, the fourth user can see user W's original pinboard collection and Y's public response but not X's private response. This occurs because the facility enforces the access control permissions indicated by users and, when displaying pinboard collections, merges data and removes duplicated data by using the “overlay” feature described above.

An information item and its annotations can appear in multiple threads. Moreover, annotations relating to an information item may be thread-specific. As an example, a user who has insufficient access control permissions to view a particular thread would be unable to see annotations of that thread.

Collecting Information Items

The facility enables information items to be collected in a pinboard collection in various ways. A user can manually add information items to pinboard collections. As examples, the user can pin an information item to a collection, such as after performing a search, while viewing or editing an information item within an application, while viewing a collection of information items, and so forth. The following provides some specific examples: a user can add a document that the user is viewing or modifying in an office productivity application to a pinboard collection, e.g., by selecting a menu command or a toolbar button and then selecting an existing pinboard collection or indicating a new pinboard collection; a user can add a file or folder to a pinboard collection when navigating a file folder hierarchy, such as when using a MICROSOFT WINDOWS EXPLORER tool; a user can indicate that all media in a “play list,” all files in a folder, or all messages in an e-mail or electronic bulletin board conversation are information items to place in a pinboard collection. In some embodiments, a user can add one or more search result links from search results provided by a search provider that is not a part of the facility, such as GOOGLE SEARCH or MICROSOFT SEARCH. As an example, the user can add these links by copying and pasting the links by dragging and dropping the links, and so forth. The user can also add any other URL, such as a website address in a similar manner. The user can then annotate any of these links added from anywhere outside the facility.

The facility can automatically add information items to pinboard collections. As an example, the facility provides an API to programmatically add RSS feeds from an RSS site or a group of RSS sites. In various embodiments, the facility's API enables an application to specify RSS sites, RSS feeds, or one or more attributes of an RSS site, RSS feed, or RSS item, e.g., to filter which of these are to be added to a pinboard collection. As a further example, the facility provides an API to convert virtually any group of information items (e.g., an e-mail thread meeting various criteria) into a pinboard collection and associated information items.

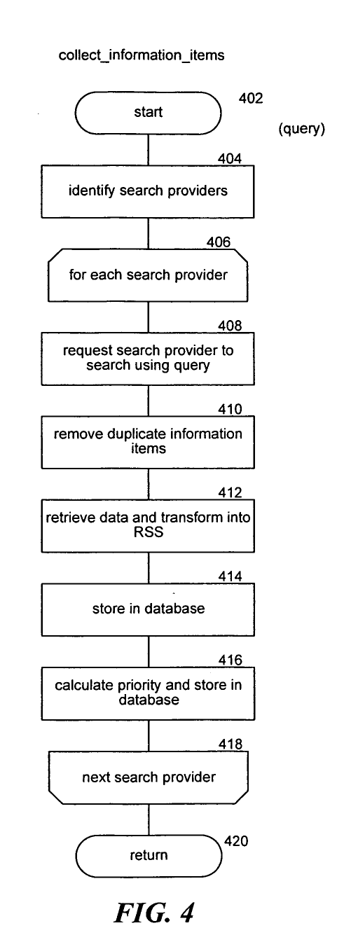

FIG. 4 is a flow diagram illustrating a collect_information_items routine that is employed by the facility in various embodiments for collecting information items. The routine begins at block 402 where it receives an indication of the query as a parameter. As an example, the routine may receive an indication of text a creator has entered as a query in a query text region.

At block 404, the routine identifies search providers the facility is configured to operate with. As an example, the routine may determine the list of search providers from a registry. As described above, the facility operates with various search providers, such as Internet search engines, desktop search engines, etc. Providers may additionally include, e.g., a primary search page associated with the facility, search providers indicated by the primary search page, and any additional search providers specified in the query, such as additional pinboard collections.

Between blocks 406 and 418, the routine requests the identified search providers to search using the received query and store results in a database. At block 406, the routine selects a search provider.

At block 408, the routine requests the selected search provider to search using the received query. Search providers may provide different application program interfaces that software applications can use to request the search providers to perform a search. Thus, the facility functions with various application program interfaces. In various embodiments, the facility may provide an extraction layer between an application program interface of the facility and an application program interface of a search provider. When this is done, a software developer can easily write a utility program or software module to facilitate communications between the facility and a search provider.

Search providers may be classified according to the types of results they generate. As an example, search providers may provide fixed, filtered, or computed results. A search provider that provides fixed results generally always returns the same set of information items associated with a query. A search provider that provides filtered results generally provides a set of information items from a larger set of information items that are filtered according to various criteria. A search provider that provides computed results generally provides results based on a computation, such as based on information items provided by other search providers.

Search providers may employ various protocols or languages to retrieve information items. As examples, search providers may employ hypertext transfer protocol, structured query language, simple object access protocol, etc. Search providers may employ these or other protocols to provide search results. In many cases, search providers may provide the results in XML.

At block 410, the routine removes duplicate information items. In various embodiments, the routine determines whether an information item is a duplicate by checking its content or identifier, such as a URL. The facility may remove or merge duplicate items received from multiple search providers. Search providers may provide a URL to identify information items located by the search providers. When multiple providers provide information relating to a URL, the facility determines whether the search providers provided duplicate information. When this is the case, the facility removes the duplicate information. Alternatively, when the multiple search providers provide different information relating to a URL, the facility combines the different information to provide an “overlay” result comprising the different information. As an example, when one search provider provides title and description attributes and another search provider provides annotation and title attributes, the overlay feature provides title, description, and annotation attributes. In various embodiments, the facility may remove the duplicate information or merge the different information after all search providers provide results. In such a case, the logic of block 410 may be performed outside the loop of blocks 406-418.

At block 412, the routine retrieves data from information items returned by the search provider and transforms the retrieved data into an internal form that the facility uses to “normalize” the retrieved data. As an example, the routine may retrieve sufficient information to form an extract relating to information items. In various embodiments, the facility uses RSS as the internal form for storing data relating to information items.

At block 414, the routine stores the transformed information in a database. In various embodiments, the database is sorted according to a URL associated with the information items. By sorting database entries by URL, information items from multiple providers can be grouped together or eliminated, as required.

At block 416, the routine calculates a priority for the retrieved information items and stores the priorities in the database. As an example, the routine may calculate a priority based on the number of times terms in the query were found in the information item. The facility can use any of the various ways of calculating priorities or relevance that are known in the art. In various embodiments, the facility dynamically computes priorities. As an example, the facility may compute priorities after it combines information items returned by all search providers.

At block 418, the routine selects another provider. When there are no more providers with which the facility is configured to operate, the routine continues at block 420, where the routine returns. Otherwise, the routine continues at block 406.

In various embodiments, the facility enables a user to select a subset of a set of search providers. As an example, a creator or recipient can identify which search providers to use to search for information items. The facility may also “discover” additional search providers. As an example, the result of a search may produce a document that contains instructions for registering and using another search provider. The facility can dynamically install and activate these search providers. Alternatively, the user may indicate which search providers to install and employ. A search provider may also indicate other search providers to employ during searching.

In various embodiments, the facility may automatically select some search providers based on the search query. As an example, when the search query includes “movie,” the facility may automatically select a search provider that is provided by an online movie rental outfit.

In various embodiments, a search provider can be shared with other users, just as information items are. When a recipient receives a search provider, the facility can register or activate the search provider for the recipient's use.

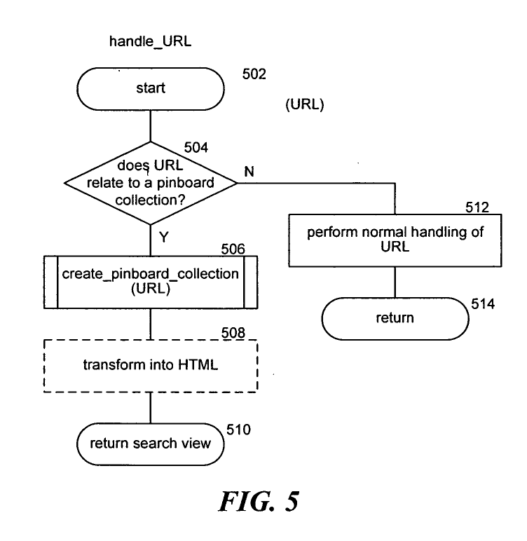

FIG. 5 is a flow diagram illustrating a handle_URL routine that is employed by the facility in various embodiments for handling uniform resource locators identifying pinboard collections. The routine begins at block 502 where it receives an indication of a URL as a parameter.

At block 504, the routine determines whether the URL relates to a pinboard collection or some other document. If the URL relates to a pinboard collection, the routine continues at block 506. Otherwise, the routine continues at block 512. In various embodiments, the facility invokes the handle_URL routine after determining that the URL relates to a pinboard collection. In such a case, the routine continues at block 506 after starting at block 502.

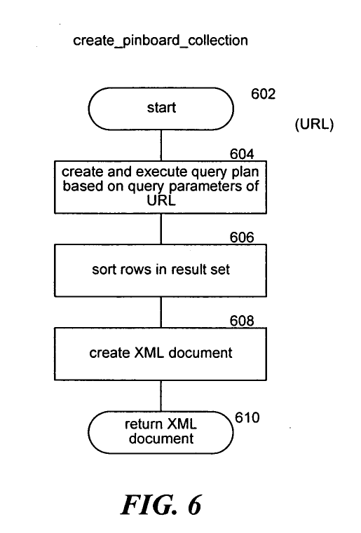

At block 506, the routine invokes a create_pinboard_collection subroutine and provides the received indication of the URL to the subroutine. The create_pinboard_collection subroutine is described below in further detail in relation to FIG. 6. In various embodiments, the routine may provide a portion of the URL when invoking the subroutine. As an example, the routine may provide the parameter portion of the URL. In various embodiments, the parameter portion of the URL is the portion of the URL's string following a question mark.

At block 508, the routine optionally transforms the created pinboard collection returned by the subroutine invoked at block 506. As an example, the routine may transform the received pinboard collection into a hypertext markup language (“HTML”). In various embodiments, the create_pinboard_collection subroutine returns pinboard collections in XML. In such cases, it may be beneficial to transform the received XML into HTML to provide the pinboard collection in a human-readable form to a user, such as using an Internet browser. In various embodiments, XSL or ASP is used to transform the XML into HTML. In various embodiments, the routine may transform the created pinboard collection into some other form of document.

At block 510, the routine returns the pinboard collection. The returned pinboard collection may be in XML, HTML, or some other form.

At block 512, the routine performs normal handling of the URL. As an example, the routine may cause a web server to return a document. At block 514, the routine returns.

FIG. 6 is a flow diagram illustrating a create_pinboard_collection routine that is employed by the facility in various embodiments for creating a pinboard collection. The routine begins at block 602 where it receives an indication of a URL as a parameter. In various embodiments, the routine may receive a portion of the URL, such as a parameter portion of the URL.

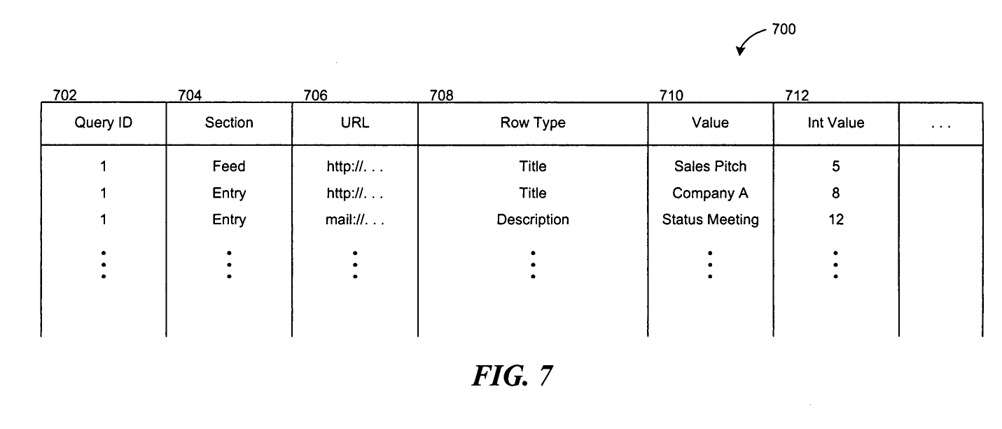

At block 604, the routine creates and executes a query plan based on the received parameters of the URL and the pinboard collection indicated by the URL. A query plan is a set of operations that adds results from various information sources to a result set to form a query. In various embodiments, the query plan is executed by a database server and the results from the information sources are added to a database table. In various embodiments, each row of the table represents an XML element of a pinboard collection file format, which is further described below. The facility creates a query plan by identifying all search providers for the pinboard collection and constructing commands that cause the identified search providers to generate results. An example of a result set stored in a table is described in further detail below in relation to FIG. 7.

In various embodiments, a document (e.g., a file) describing a pinboard collection contains information about a location for an object, such as executable code, that the facility may employ to obtain search results from a search provider and to convert the provided results into a form utilized by the facility. As an example, the pinboard collection may contain a location and name of a dynamic link library that provides these functions.

In various embodiments, the facility uses a relational database system, such as MICROSOFT SQL SERVER or an ORACLE database software, to store search results.

In various embodiments, pinboard collections contain indications of other pinboard collections or search providers as pinned information items. When this is the case, the facility may additionally search for or retrieve information items referenced by these other pinboard collections and pinned information items. When a pinboard collection references a search provider, the facility downloads relevant information from an indication of the search provider. As an example, a search provider may be indicated by a link. The facility utilizes this downloaded information when querying the search provider to convert its results into a form that the facility utilizes internally.

In various embodiments, an information item or pinboard collection may be indicated as “active” within a pinboard collection. As an example, when a search locates a potential search provider, a user may be able to activate the found search provider. When this is the case, the facility may employ active search providers to perform further searching relating to the pinboard collection.

At block 606, the result set is sorted. As an example, when the result set is stored in a database table, the rows of the database may be sorted according to values in one of the columns of the table.

In various embodiments, the facility uses a database table having a form that is described in greater detail below in relation to FIG. 7. In such embodiments, the facility may sort the database table as follows. The database table is first sorted by a section column. Each section is then sorted according to where in a display results page data contained in the rows are to be displayed. The rows in each section are then sorted by priority so that information items having a higher priority appear before information items having a lower priority. The rows in each section are next sorted by URL so that information items from a particular URL are grouped together. In various embodiments, the rows may be further sorted, such as by row type, value, and intValue columns. These columns are described in further detail below in relation to FIG. 7.

At block 608, the routine creates an XML document from the rows of the result set. In various embodiments, the facility inserts default values for missing rows that may be required. As an example, RSS may utilize various XML elements when defining feeds and entries. However, these elements may not be provided by the search providers. In such a case, the routine may add default values for these elements. In various embodiments, the facility may eliminate duplicate rows. As an example, multiple search providers may provide similar or identical XML elements for a given information item. When the schema permits, the facility may not remove some duplicate values. In various embodiments, the facility may add XML nodes or elements. As an example, the facility may add XML nodes to complete a pinboard schema. In various embodiments, the facility performs the collect_information_items routine described above in relation to FIG. 4 when executing the logic of block 608.

At block 610, the routine returns the XML document.

In various embodiments, the pinboard collection file format is based on RSS. As an example, the pinboard collection file format may be based on RSS version 2.0, which is described at the Internet site blogs.law.Harvard.edu/tech/RSS. RSS defines a feed and an entry. A feed identifies a source for information items. An entry describes aspects of information items, such as extracts.

In various embodiments, the facility extends RSS. As an example, the facility may add text and search provider elements to RSS feeds. The text element may be used to identify queries. As an example, a query used to generate a pinboard collection may be stored in the text element. The search provider element may be used by the facility to locate search providers relating to a pinboard collection.

As a further example, the facility may also add various elements to RSS entries, including type, extract, modified, memo, access, and source elements. The type element may be used to indicate a type of information item, such as a web page or spreadsheet. The extract element may be used to store an extract relating to an information item. The modified element may be used to store a last modification date or time of the pinboard collection. The memo element may be used to store annotations or other information relating to a pinboard collection or an information item. The access element may be used to store indications of how access control permissions (“ACPs” or simply “permissions”) are propagated or inherited in relation to the information item. The source element may be used to store which search provider provided an information item.

FIG. 7 is a table diagram illustrating a result set table created by the facility when executing a query plan in various embodiments. The result set table 700 has a query ID column 702, a section column 704, a URL column 706, a row type column 708, a value column 710, and an integer value column 712. The table contains a “shredded” collection of information items from a pinboard collection.

The query ID column 702 uniquely identifies each query used to generate the result corresponding to the row of the table. Because the facility may handle multiple simultaneous queries, the facility can use this unique identifier to determine the correspondence between queries and rows in the result set table. Thus, when querying the result table, the facility may filter by query ID.

The section column 704 identifies the section corresponding to each row. As an example, the section column identifies whether a row relates to a feed for an entry. As previously described, portions of files defining pinboard collections relate to feed entries.

The URL column 706 identifies the URL from which the information item relating to the row was retrieved.

The row type column 708 identifies the type of RSS element that is stored in the row. As examples, the row type for rows may be title, publication date, description, etc.

The value column 710 stores the actual XML data for the element associated with the row.

The integer value column 712 stores an integer representation for each row. The facility may use this column to sort rows. As an example, this column may store relevance or rank information. When the facility sorts results, it may use this column to group information items of similar relevance or rank together.

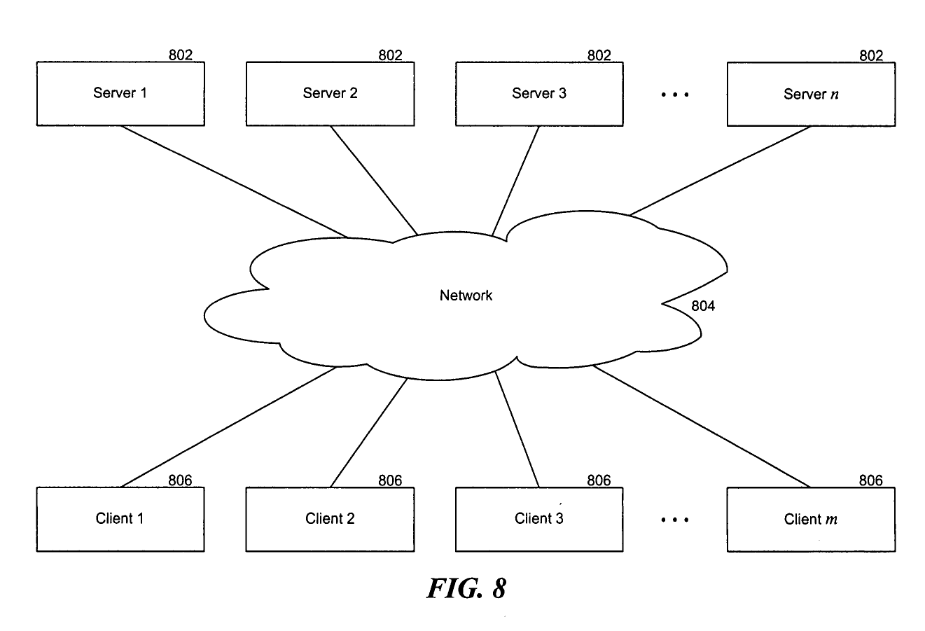

FIG. 8 is a block diagram illustrating a suitable environment in which the facility may operate in various embodiments. The environment has one or more server computing devices 802 that can be connected via a network 804 to one or more client computing devices 806.

The server computing devices may be web servers, e-mail servers, database servers, file servers, sources of information items, etc. In various embodiments, a server may provide multiple services or applications concurrently.

The network may be the Internet, an intranet, or any combination of data communications networks, including wireless or wired networks.

The client computing devices may be employed by users, such as creators or recipients, to create, view, or manipulate pinboard collections.

In various embodiments, the facility may employ several servers, and each user may be associated with one of the servers. However, users do not need to be aware of which server they are associated with. The facility ensures that users have access to all information they have been provided access to. The facility may replicate information, such as when an information item that is pinned to a pinboard collection is unavailable from the domain of the server with which the user is associated. The replication feature is described in further detail below. When a user requests the facility to perform a search, the associated server may perform the search even if the user provided the search request to another server of the facility. Any pinboard collections and information items that are stored by the facility are generally also stored on a storage device that is associated with the associated server.

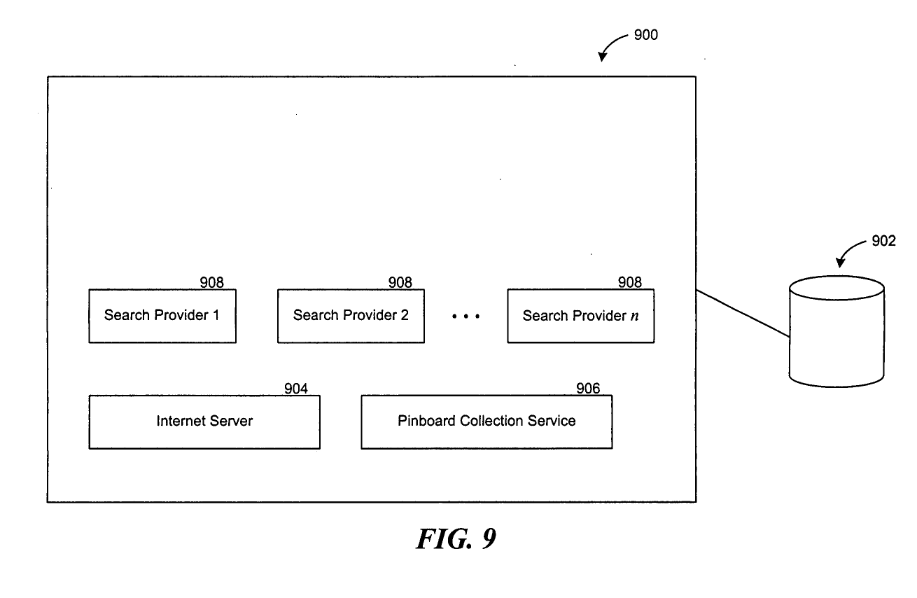

FIG. 9 is a block diagram illustrating aspects of a server of FIG. 8 in further detail in various embodiments. A server 900 may be connected to a database 902. In various embodiments, the database may be stored in the server 900. In other embodiments, the database may be stored in another server that is connected to the server 900.

The server 900 additionally comprises various software components, such as an Internet server 904, a pinboard collection service 906, and one or more search providers 908.

The Internet server is a conventional service that responds to requests containing URLs by evaluating the URL, performing some logic, and returning information relating to the URL. As an example, when the URL relates to a document, the Internet server responds by loading the document and sending the document's content to the requester. When the URL relates to a pinboard collection, the Internet server responds by causing the pinboard collection service 906 to create the pinboard collection and returning the created pinboard collection's contents to the requester.

The pinboard collection service 906, upon receiving an indication to create a pinboard collection, may employ one or more search providers 908 to search for information items. The pinboard collection service assembles these information items as a part of a query plan, as described above, into a search result. The pinboard collection service may then create the pinboard collection from the search result. In various embodiments, the pinboard collection service may transform the created search result into a form that the requesting client computing device is capable of displaying to a user. As an example, the pinboard collection service may transform the created search result into HTML from XML.

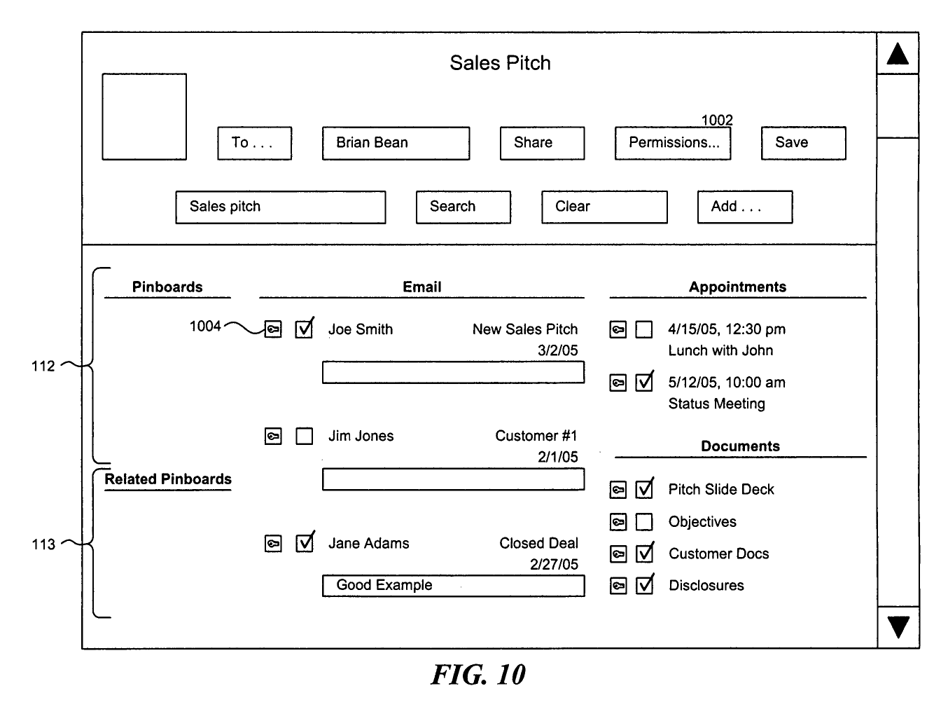

FIG. 10 is a display diagram illustrating a display results page provided by the facility in various embodiments. The illustrated display diagram is similar to the display diagram of FIG. 2 except that it additionally has a permissions button 1002 and multiple information item permissions buttons 1004.

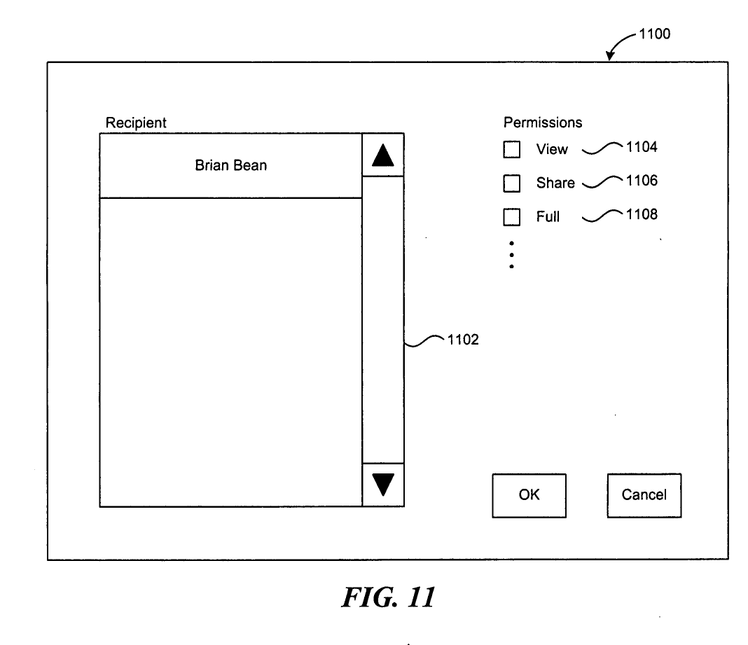

The permissions button 1002, when selected, causes the facility to display a permissions user interface, which is described in further detail below in relation to FIG. 11. When the user dismisses the permissions user interface, such as by selecting an okay or apply button, the facility applies permissions indicated in that user interface to the pinboard collection for which the permissions button 1002 was selected. Thus, a creator or recipient may be able to set or reset permissions relating to a pinboard collection. As an example, the creator may be able to indicate that recipients do not have the permissions to further share a pinboard collection that the creator sends to the recipients.

The information item permissions buttons 1004 are associated with each information item displayed in a pinboard collection. When the display results page displays additional pinboard collections, such as in the pinboard collections results region 112, the facility may also provide additional information item permissions buttons 1004 that are associated with the additional displayed pinboard collections. When a user selects one of the information item permissions buttons 1004, the facility displays a permissions user interface, which is described in further detail below in relation to FIG. 11. In various embodiments, the user interface the facility provides for setting permissions for pinboard collections (e.g., user interfaces invoked by the permissions button 1002) may be different from the user interface invoked for setting information item permissions. When the user dismisses the permissions user interface, such as by selecting an okay or apply button, the facility applies permissions indicated in that user interface to the information item or additional pinboard collection corresponding to the information item permissions button 1004 that was selected by the user. Thus, a creator or recipient may be able to set or reset permissions relating to information items or additional pinboard collections indicated in a pinboard collection. As an example, the creator may be able to indicate that particular recipients do not have the permissions to view some of the information items that were pinned by the creator to a pinboard collection.

FIG. 11 is a display diagram illustrating a user interface for indicating permissions employed by the facility in various embodiments. The user interface 1100 may provide a list of recipients, such as in a list box 1102. In the illustrated example, Brian Bean is indicated as a recipient. The user interface may also provide a list of permissions, such as permissions 1104, 1106, and 1108.

A user, such as a creator or a recipient, can specify permissions relating to a pinboard collection or information item by selecting one or more recipients from the recipient list and then indicating permissions the facility should provide to the selected recipients. The illustrated user interface indicates a view permission 1104, a share permission 1106, and a full permission 1108, though other permissions are possible and contemplated.

When a user indicates one or more of the permissions, the facility applies the permissions to the item for which the user interface was invoked. As examples, the facility may apply the indicated permissions to information items or pinboard collections depending on whether the user selected the permissions button 1002 or one of the information item permissions buttons 1004.

When a recipient has the view permission, the facility enables the recipient to view the associated item. The facility may not enable a recipient to view an information item or pinboard collection when the recipient does not have the view permission.

When a recipient has the share permission, the facility enables the recipient to share the associated item with other recipients. As an example, a recipient that has the share permission can share a received pinboard collection with other recipients. When a recipient shares a received pinboard collection having some information items for which the recipient has share permissions and other information items for which the recipient does not have share permissions, downstream recipients may receive only the information items for which the sharing recipient has the share permission.

When a recipient has full permission to an item, the facility enables the recipient to view the item, share the item, or modify the item. The facility may also enable such a recipient to add additional items.

Information items and pinboard collections can have various relationships according to which the facility determines access control permissions (“ACPs”). These relationships can be, e.g., “none,” “propagate,” “inherit,” and “both.” The facility may also define other relationships. When a pinboard collection or information item has no relationship, the facility does not need to calculate an ACP for that pinboard collection or information item based on other pinboard collections or information items, but may nevertheless display the pinboard collection, e.g., as a related pinboard collection. When a pinboard collection or information item has a propagate relationship, the facility calculates ACPs for that pinboard collection or information item based on ACPs determined or indicated for pinboard collections to which that pinboard collection or information item is pinned. When a pinboard collection or information item has an inherit relationship, the facility calculates ACPs for pinboard collections to which that pinboard collection or information item is pinned. In various embodiments, the facility specifies a relationship automatically when an information item or pinboard collection is pinned. As an example, the facility may select a propagate relationship by default. In various embodiments, the facility may provide a default relationship but a user may modify the relationship. The user interface for modifying the relationship may be associated with the user interface in FIG. 11. As an example, the user interface of FIG. 11 may be extended to enable the user to select the relationship, such as by selecting a relationship from a list of relationships. In various embodiments, the user interface for selecting a relationship may be via a drop-down menu that appears in a display results page or pinboard collection, such as the display results page illustrated in FIG. 10.

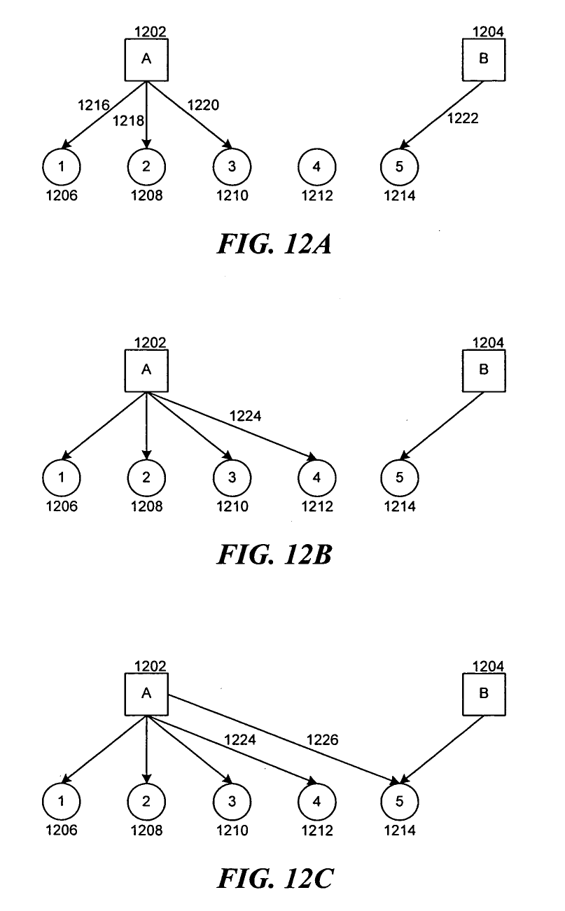

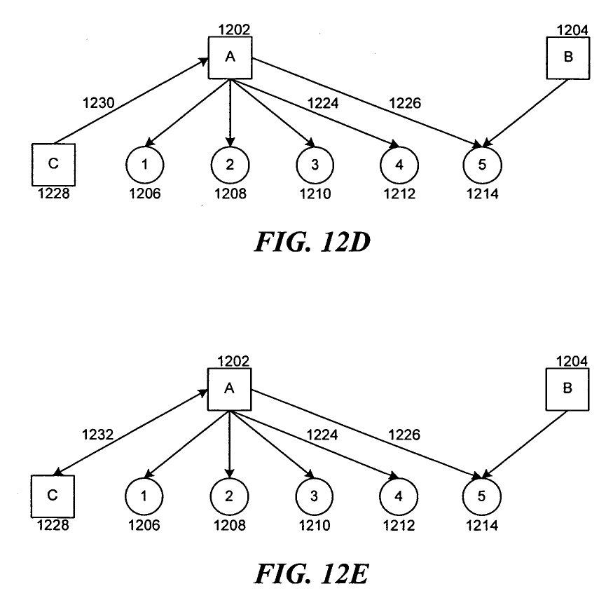

These relationships will now be further explained by reference to FIGS. 12A-12E, which are block diagrams illustrating relationships between pinboard collections and information items for determining permissions in various embodiments. These figures illustrate directed graphs having squares representing pinboard collections and circles representing information items. Edges connecting pinboard collections and information items indicate that a pinboard collection or information item is pinned to the pinboard collection with which it shares an edge. Arrows indicate the direction in which ACPs flow. As an example, according to FIG. 12A, ACPs propagate from the pinboard collections to the information items. An information item or pinboard collection that appears below a pinboard collection with which it shares an edge is pinned to the pinboard collection above it. The illustrated nodes may also have other relationships that are not illustrated.

According to FIG. 12A, there are two pinboard collections: pinboard collection A 1202 and pinboard collection B 1204. Pinboard collection A has pinned to it information items 1 1206, 2 1208, and 3 1210. Pinboard collection B has pinned to it information item 5 1214. Information item 4 1212 is not indicated to be pinned to either pinboard collection.

Suppose users X, Y, and Z have full permissions on pinboard collection A but none of these users have any permissions on information item 4. If users X, Y, or Z somehow locate information item 4, they would be unable to view that information item, e.g., because an operating system's file system indicates that these users do not have the necessary ACPs. Suppose further that user W has full privileges on pinboard collection A and read privileges on information item 4. User W can thus pin information item 4 to A, as indicated in FIG. 12B.

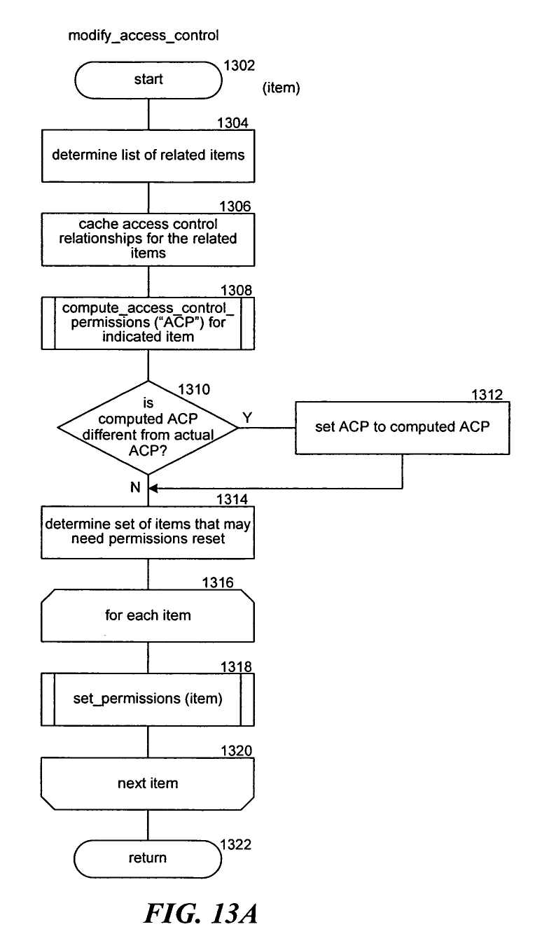

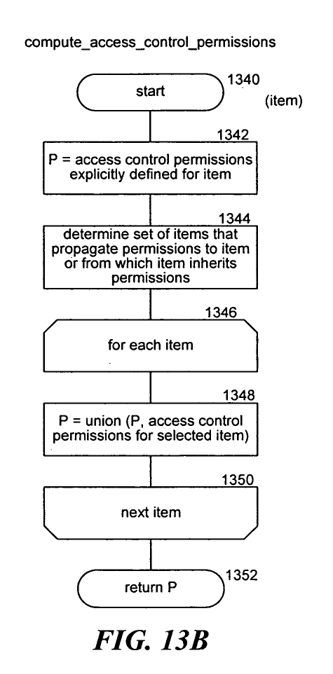

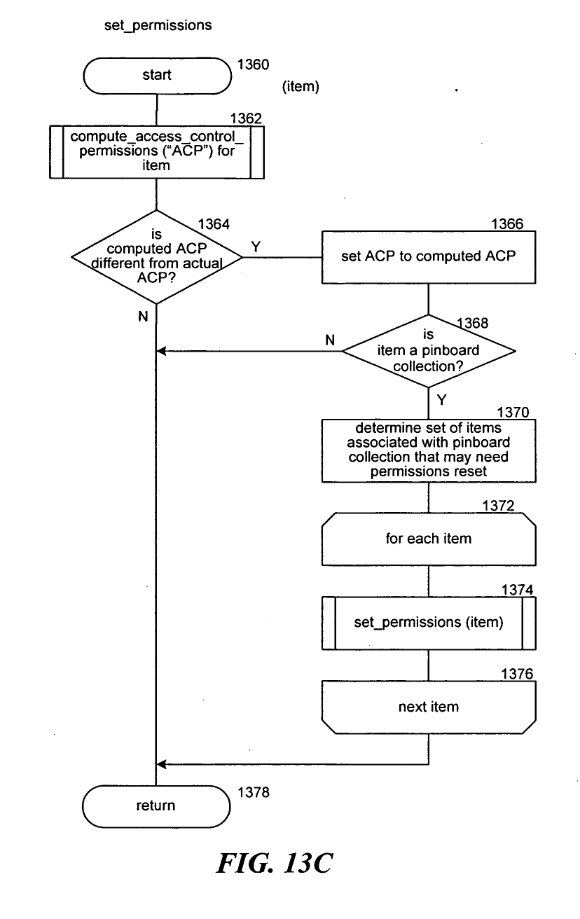

When a user modifies a pinboard collection, such as by pinning a new item, the facility may recalculate ACPs for all information items and pinboard collections pinned to the pinboard collection. Routines to calculate or set ACPs are described in further detail below in relation to FIGS. 13A-C.

Information item 4 has a “propagate” relationship, as indicated by a directed edge from the pinboard collection to information item 4. As a result, once information item 4 is pinned to pinboard collection A, information item 4's ACPs are calculated to be the union of the ACPs for pinboard collection A and any ACPs explicitly indicated for information item 4. In this example, users X, Y, and Z, who previously had no permissions on information item 4, would have full permissions on information item 4 after this item is pinned to pinboard collection A. This is because these users had full permissions on pinboard collection A, which has a propagate relationship with information item 4.

Suppose user Z has share permissions on pinboard collections A and B and information item 5, and user W has no permissions on information item 5 but has full permissions on pinboard collection A. Additionally, suppose user Z pins information item 5 to pinboard collection A as indicated in FIG. 12C. The facility then recalculates ACPs for information item 5 as a union of the permissions on pinboard collections A and B. After the recalculation, user W would have full permissions on information item 5 because the ACPs of pinboard collections A and B are propagated to information item 5 and so user W's permissions on pinboard collection A propagate to information item 5.

FIG. 12D illustrates an inherit relationship. According to FIG. 12D, pinboard collection A inherits ACPs from pinboard collection C 1228, as indicated by edge 1230, which has an arrow indicating the inherit relationship. Thus, even though pinboard collection C is pinned to pinboard collection A, it is pinboard collection A that inherits ACPs from pinboard collection C. Upon the occurrence of various events, the facility recalculates pinboard collection A's ACPs based on ACPs of pinboard collection C. Based on the propagate relationship with information items 1-5, these ACPs may also flow to those information items. As an example, if user V has view permissions on pinboard collection C, that user will also receive view permissions on information items 1-5.

FIG. 12E illustrates a relationship between pinboard collections A and C that flows in both directions (e.g., the relationship is both inherit and propagate). In this case, ACPs flow from pinboard collection C to pinboard collection A and from pinboard collection A to pinboard collection C. When a relationship flows in both directions between two nodes, the facility synchronizes the ACPs of both nodes. The facility may detect and prevent infinite loops when this occurs.

In various embodiments, the facility recalculates ACPs when various events occur. These events include, e.g., when an information item is pinned to a pinboard collection or is no longer pinned to a pinboard collection, when ACPs are modified for an information item (e.g., manually or as a result of being pinned to another pinboard collection), or from time to time (e.g., periodically or randomly).

As described above, the facility can function with relationships between pinboard collections and information items that can be represented as a directed graph. This is in contrast to most access control schemes that are conventionally represented by trees. Because ACP inheritance is represented as a directed graph, complex relationships can be defined for inheritance and propagation of ACPs. Each node of the directed graph represents an information item or pinboard collection and each directed edge indicates a relationship defining how ACPs flow. The computed ACPs for any given node are the union of ACPs explicitly set for that node and the ACPs of every other node from which a directed edge is indicated. Taking the directed graph of FIG. 12E as an example, suppose the ACPs for information item 5, pinboard collection A, and pinboard collection B are respectively K, L, and M. The computed ACPs for information item 5 would be (K union L union M). As is known in the art, a union operation on multiple source sets produces a result set that is the smallest combination of all elements in the two sets.

The facility can use a variety of techniques to ensure that recalculation of ACPs is not an endless loop, such as when a graph defining relationships has a cycle. As an example, the facility can stop recalculating links when ACPs already applied to a pinboard collection or information item match ACPs calculated by the facility for the pinboard collection or information item.

In various embodiments, the facility interacts with an operating system to retrieve or set ACPs. As an example, when calculating permissions in an inherit relationship from an information item to a pinboard collection, the facility may query the operating system to determine what ACPs are explicitly set on the information item. As another example, upon calculating ACPs for an information item, the facility may request the operating system to set the ACPs for the information item. In various embodiments, the facility caches the ACPs in a database, such as to improve performance or augment the ACPs.

In some embodiments, ACPs are managed by the facility in addition to, or in spite of, other access control mechanisms employed by other objects employed by the facility (e.g., objects that store information items), such as the file system, database, and so forth. In some embodiments, the facility propagates ACPs through a query rather than, or in addition to, with an information item. As an example, the ACP may propagate to any information item (e.g., in a pinboard collection) containing a specified search term. In such embodiments, pinboard collections can either be stored or computed dynamically.

FIGS. 13A-13C are flow diagrams illustrating routines that are employed by the facility in various embodiments for modifying ACPs. These routines may be employed by the facility at various times, such as when the facility detects that a pinboard collection has changed. The facility may perform portions of these routines in a user context and other portions in a system context. When logic of the routine is performed in a user context, only actions that the operating system enables the user to perform can actually be performed. In contrast, when logic of the routine is performed in a system context, all actions that the operating system is capable of performing can actually be performed.

FIG. 13A is a flow diagram illustrating a modify_access_control routine that is employed by the facility in various embodiments for modifying access control (e.g., permissions or privileges). The routine begins at block 1302 where it receives an indication of an item as a parameter. The indicated item can be, e.g., a pinboard collection or a information item.

At block 1304, the routine determines a set of related items. Related items are other pinboard collections or information items that propagate ACPs to the indicated item or from which the indicated item inherits ACPs.

The facility may optionally cache these relationships in a database, as is indicated at block 1306. As an example, the facility may create one or more database tables having rows indicating each information item or pinboard collection view and the relationship with other information items and pinboard collections that the facility added to the table. Each information item or pinboard collection may be uniquely identified in the table. Each row of a table may contain a unique identifier for an item, a location of the item, and ACPs for the item. Another table may have rows containing unique identifiers of items, access control relationship (e.g., inherit, propagate, both, or none), and a unique identifier of the item with which the item associated with the row is related.

At block 1308, the routine may invoke a compute_access_control_permissions subroutine to compute the ACPs for the indicated item. This routine is further described immediately below in relation to FIG. 13B.

At block 1310, the routine determines whether the computed ACPs are different from the ACPs actually indicated for the item, such as by querying an operating system on which the item is located. If the calculated ACPs are different from the actual ACPs, the routine continues at block 1312. Otherwise, the routine continues at block 1314.

At block 1312, the routine sets the actual ACPs for the item to the computed ACPs. As an example, the routine may invoke an application program interface of an operating system on which the item is located to set the item's ACPs. Alternatively, or in addition, the routine may change the item's ACPs in a database or other application storing ACPs of items. As an example, the facility may invoke an application program interface provided by an e-mail server to set an e-mail item's ACPS.

At block 1314, the routine determines a set of items that may also need their ACPs reset when ACPs for the indicated item changes. As an example, information items and pinboard collections pinned to a pinboard collection may need their ACPs reset. As another example, other items that have an inherit relationship with the indicated item may need their ACPs reset.

Between the loop of blocks 1316 and 1320, the routine resets the ACPs for each item of the determined set of items. At block 1316, the routine selects an item from the set.

At block 1318, the routine sets the ACPs for the item by invoking a set_permissions subroutine, which is described below in relation to FIG. 13C. The routine may provide an indication of the selected item as a parameter to the set_permissions routine.

At block 1320, the routine selects another item from the set. If all items of the set have already been processed by the loop, the routine continues at block 1322, where it returns. Otherwise, the routine continues at block 1318.

FIG. 13B is a flow diagram illustrating a compute_access_control_permissions routine that is employed by the facility in various embodiments for computing ACPs. The routine begins at block 1340 where it receives an indication of an item as a parameter. The item can be, e.g., an information item or a pinboard collection.

At block 1342, the routine determines a set of ACPs explicitly defined for the indicated item. As an example, the routine may determine the explicit ACPs by querying an operating system on which the item is located or by looking up the explicit ACPs in a database. The routine sets a variable (illustrated as “P”) to contain the ACPs.

At block 1344, the routine determines a set of items that either propagate ACPs to the indicated item or from which the indicated item inherits ACPs. As an example, the routine may determine this information by querying the database described above in relation to block 1306.

Between the loop of blocks 1346 and 1350, the routine computes the ACPs for the indicated item by performing a union operation on the ACPs of all items in the determined set of items. The routine selects an item from the set at block 1346.

At block 1348, the routine performs a union operation between the ACPs contained in the variable set at block 1342 (e.g., “P”) and the ACPs of the selected item. The result of the union is stored in the variable and reused during a subsequent iteration of the loop.

At block 1350, the routine selects another item from the list. When all items have been processed, the routine continues at block 1352, where it returns the computed ACPs, which are now stored in the variable. Otherwise, the routine continues at block 1348.

FIG. 13C is a flow diagram illustrating a set_permissions routine that is employed by the facility in various embodiments for setting ACPs. The routine begins at block 1360 where it receives an indication of an item as a parameter. The item can be, e.g., an information item or a pinboard collection.

At block 1362, the routine invokes the compute_access_control_permissions subroutine described above in relation to FIG. 13B to compute the ACPs for the indicated item.

At block 1364, the routine determines whether the computed ACPs are different from the ACPs actually indicated for the item, such as by querying an operating system on which the item is located. If the calculated ACPs are different from the actual ACPs, the routine continues at block 1366. Otherwise, the routine continues at block 1378.

At block 1366, the routine sets the actual ACPs for the item to the computed ACPs. As an example, the routine may invoke an application program interface of an operating system on which the item is located to set the item's ACPs. Alternatively or in addition, the routine may change the item's ACPs in a database storing ACPs of items.

At block 1368, the routine determines whether the item is a pinboard collection. The routine makes this determination because items associated with a pinboard collection may need their ACPs reset. If the item is a pinboard collection, the routine continues at block 1370. Otherwise, the routine continues at block 1378.

At block 1370, the routine determines a set of items associated with the pinboard collection that may need permissions reset. As an example, the routine may determine this information by querying the database described above in relation to block 1306.

Between the loop of blocks 1372 and 1376, the routine sets ACPs for items in the determined set. The routine selects an item from the set at block 1372.

At block 1374, the routine recursively calls the set_permissions routine to set ACPs for the selected item, which the routine provides as an indication.

At block 1376, the routine selects another item. When all items have been processed, the routine continues at block 1378. Otherwise, the routine continues at block 1374.

At block 1378, the routine returns.

In various embodiments, the facility enables a user to specify information items from which a pinboard collection is to inherit permissions that are not pinned to the pinboard collection.

In various embodiments, the facility enables a user, such as an administrator, creator, recipient, or other user, to specify a “mask” that is to be applied when modifying permissions. When the facility applies a mask, it may not apply all permissions. Examples of masks are normal and custom. When the mask is normal, the facility may calculate the permissions as described above. A user can specify a maximum normal mask. As an example, a user can specify a maximum mask of “share.” When this is the case, the facility may apply view and share permissions, but not full permissions because full permissions exceed share permissions. When the mask is custom, the facility may apply a custom mask that is specified by a user.

In various embodiments, the facility modifies operating system permissions indicated for a file, such as a file containing an information item. As an example, the facility may modify operating system permissions for a file when a pinboard collection containing an information item corresponding to the file is shared with a recipient who does not have read privileges for the file.

In various embodiments, the facility can change permissions “in band” or the permissions can change “out of band,” such as by another application or manually by a user. As an example of an “in band” change, permissions for a pinboard collection, information item, or file may change when a pinboard collection is shared with recipients. As an example of an “out of band” change, a user can change the permissions for an information item using an operating system component or command. When either occurs, the facility may recompute permissions for pinboard collections or information items.

In various embodiments, the facility may track items for which it has already recalculated ACPs. Then, when a loop or a recursion causes the facility to again visit an item, the facility does not need to again recalculate ACPs for the item visited again.

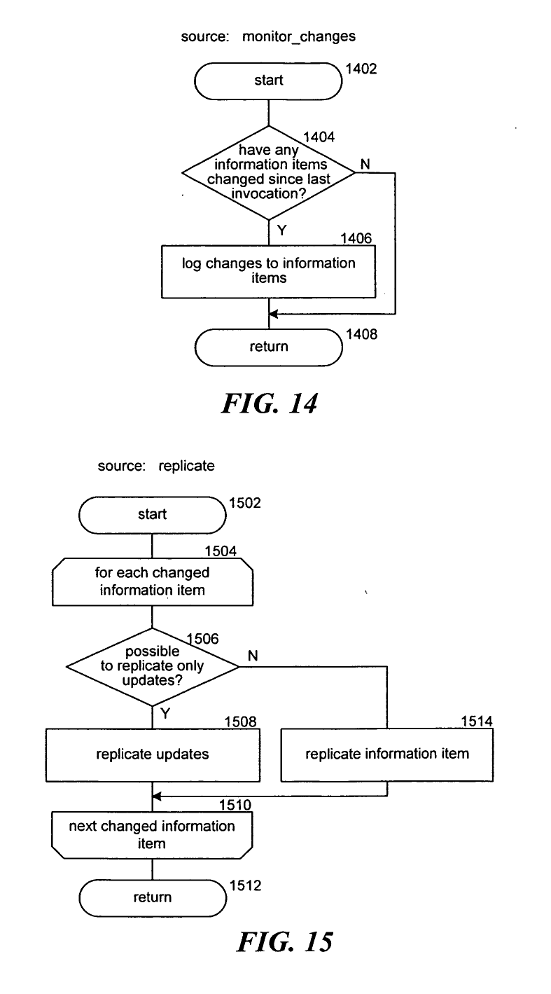

FIG. 14 is a flow diagram illustrating a monitor_changes routine that is employed by the facility in various embodiments for monitoring changes to information items. In various embodiments, the facility employs the monitor_changes routine to detect changes to information items, such as content changes or permissions changes. The routine begins at block 1402.

At block 1404, the routine determines whether any information items have changed since the last invocation of the routine. The routine may track content changes, permissions changes, or other changes. If such is the case, the routine continues at block 1406. Otherwise, the routine continues at block 1408 where it returns.

At block 1406, the routine logs changes to information items. As an example, the routine may log the changes in a database of changes. In various embodiments, the routine may log an indication that an information item has changed but not the actual change.

At block 1408, the routine returns.

In various embodiments, the monitor_changes routine is performed by a source computing device. A source computing device is a device that propagates changes to other computing devices. As an example, a source computing device replicates changes to other computing devices.

In various embodiments, additional processes can be undertaken based on changes to the content or permissions of information items. As an example, a workflow application could be developed to create a task indicating that user X should review the document when permissions on an information item change to enable user X to view the information item. Thus, the facility describes a generic architecture for building applications based on monitoring changes, such as permission changes.

In various embodiments, attributes of information items may propagate in a manner similar to ACPs. As an example, a version locking information attribute may propagate (or inherit), so that when a user “locks” a pinboard collection, the lock could apply to all information items contained in the locked pinboard collection and any other pinboard collections it contains. When a lock is applied to a pinboard collection, the facility may replace URLs (or other links) identifying information items so that selecting the URL would, for example, load a version of the information item corresponding to the version that was available when the pinboard collection was locked. In such a case, the facility may create a “locked version” and provide the URL. This locking may occur recursively to all information items in pinboard collections contained by the locked pinboard collection.

FIG. 15 is a flow diagram illustrating a replicate routine that is used by the facility in various embodiments for replicating changes. The facility may perform the routine from time to time to replicate changes from a source computing device to other computing devices, such as servers or clients. The routine begins at block 1502.

Between blocks 1504 and 1510, the routine replicates information items. At block 1504, the routine selects an information item that has changed. As an example, the routine may select the information item from the log that is created by the monitor_changes routine of FIG. 14.

At block 1506, the routine determines whether it is possible to replicate only updates of the changed information item. As an example, some documents may store revisions or updates made to the documents. When this is the case, it may be efficient to replicate only the updates rather than the entire document. If it is possible to replicate only updates, the routine continues at block 1508. Otherwise, the routine continues at block 1514.

At block 1508, the routine replicates updates. As an example, the routine may provide the update to another computing device.

At block 1510, the routine selects another information item. If all information items have been processed, the routine continues at block 1512 where it returns. Otherwise, the routine continues at block 1506.

At block 1514, the routine replicates the information item. As an example, the routine may provide the information item to another computing device.

In various embodiments, the computing device to which the information items or updates are replicated may batch the updates. As an example, the computing device may receive a number of updates or information items before updating its local copy. In various embodiments, the computing device that receives the updates or information items may forward the updates or information items to other computing devices. As an example, upon detecting that a information item is shared with a particular user, the computing device may forward the information item to a server corresponding to that user.

Computing devices may share updates as XML updategrams. XML updategrams provide indications of updates in XML messages.

The facility can perform the replication, e.g., by sending the updategrams, using various protocols. As an example, the facility can use the HTTP protocol with a variant of a distributed authoring and versioning (“DAV”) protocol to enable replication. The facility detects whether the user is “inside” or “outside” a firewall by checking the computing device's network connection. Based on whether the computing device is inside or outside the firewall, the computing device determines which URLs to use. As an example, when the computing device is inside the firewall, the URL may reference local server names, such as http://internalserver/share. When the computing device is outside the firewall, the URL may reference an Internet domain, such as http://www.companyname.com/share.

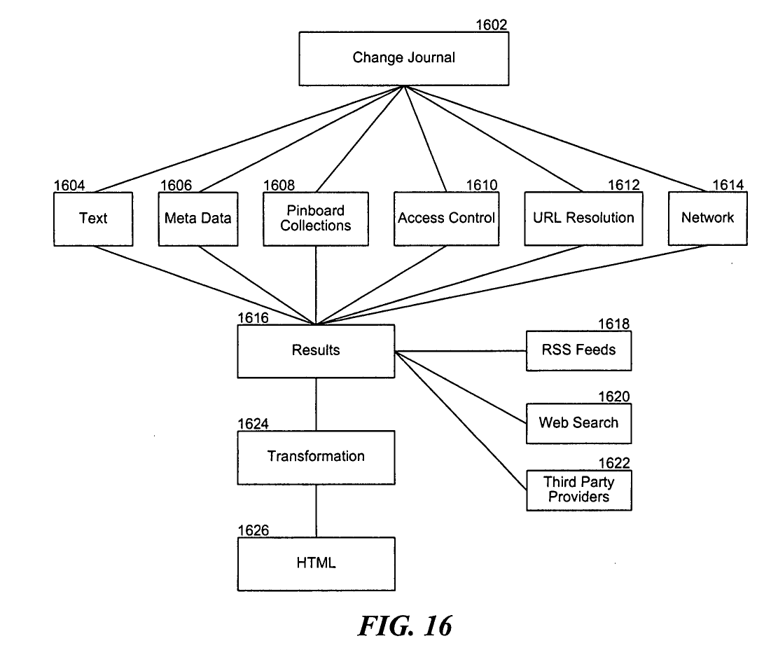

FIG. 16 is a block diagram illustrating components for and aspects of the facility's use of multiple search providers. In various embodiments, the facility employs an operating system's change journal 1602. As an example, an embodiment of the system configured to use the MICROSOFT WINDOWS operating system may use an “NT change journal.” An operating system's change journal records changes to files and other objects of the operating system. By employing the change journal, the facility is able to detect changes to files, pinboard collections, information items, etc.

The facility then propagates indications of the changes to various indices. As examples, the facility may propagate changes to documents to a text index 1604, changes to schemas used by the facility to a metadata index 1606, changes of locations of documents to a pinboard collections index 1608 (e.g., to fix links when documents are moved), changes to ACPs to an access control index 1610, and changes relating to locations of files to a URL resolution index 1612. In various embodiments, a replication engine (not shown) may replicate changes from the change journal to a computing device on a network 1614, such as a server, so that information can be kept up to date across networks.

As and when the information from the indices is needed, or at various other times, the facility merges information contained or indicated by the indices to create results 1616. By combining this information with information provided by search providers, the facility creates search results. As an example, the facility may merge information contained or indicated by the indices with information provided by an RSS search provider 1618, web search provider 1620, or one or more third-party search providers 1622. The facility can employ various communications protocols to communicate with the RSS, web, or other search providers.

The facility may store the search results in a normalized format, such as in an internal format or RSS.

In various embodiments, the facility transforms the search results by applying a transformation 1624. The transformation can create any of a number of types of documents, such as an HTML document 1626.

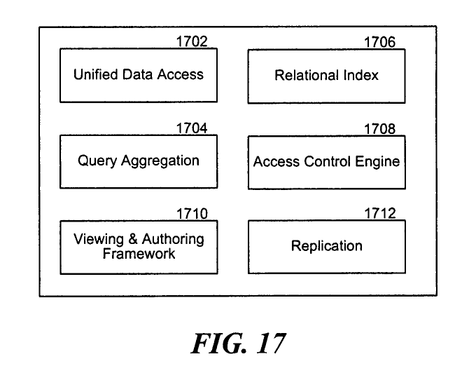

FIG. 17 is a block diagram illustrating various components employed by the facility. In various embodiments, these components can be utilized alone or jointly to make use of some features of the facility. The facility may also employ additional components that are neither illustrated nor described herein.

To enable applications using the facility to load or manipulate a wide variety of information, a unified data access component 1702 functions with data stored in disparate data sources and having disparate data types. The unified data access component is extensible in such a manner that it can function with additional sources and types of data.

A query aggregation component 1704 combines query results from different sources to create a unified result. The query aggregation component functions with multiple query protocols and synchronous or asynchronous responses, and may provide extracts in an internal format based on the results.

A relational index component 1706 builds relational indices based on information items. The indices enable applications or users to perform full text queries on the indexed data, thereby enabling use of back links and related links. A back link is a link identifying a pinboard collection to which an item is pinned.

An access control engine 1708 creates an access control flow graph based on a database (e.g., a database that stores ACPs for pinboard collections and information items) and tracks and updates ACPs based on the created access control flow graph. This component enables the facility to provide a rich collaborative user model by setting or resetting permissions on pinboard collections and information items so that appropriate users can view, modify, and share information.

A viewing and authoring framework 1710 generates user interfaces from search results and enables editing. As an example, the viewing and authoring framework may create a user interface by transforming combined extracts using XSL. The user interface may have text regions for receiving annotations.

A replication component 1712 enables the facility to provide seamless offline and online capabilities. It enables replication between servers and between clients and servers. As an example, it may replicate pinboard collections and information items between servers so that users of different domains can access the information. The replication component may replicate pinboard collections and information items between servers and clients to enable a user to seamlessly view information when the client is disconnected from the server. As an example, a user may indicate to make various pinboard collections available offline. When this is done, pinned information items and pinboard collections (and the information items pinned to these pinboard collections) may also be available offline. The results of database searches, e-mails, or other information items may also be made available offline in a static manner. When doing the replication, the replication component ensures that ACPs are appropriately enforced. When the client is reconnected to the server, the replication component may synchronize offline updates to the server, such as annotations made while offline.

As can be readily appreciated, the facility combines addressability of e-mail with navigational ease of Internet browsers and simplicity of search to enable information exchange. The facility enables users to create personal information networks that are updateable and searchable and that comprise pinboard collections containing links to information items. These pinboard collections and information items can be annotated and shared in a secure manner.

In various embodiments, the facility enables searching across various data types (e.g., e-mail, databases, file systems, etc.) and data sources (Internet, intranet, personal computing devices, etc.) using various terms, including enabling multiple searches to locate a specific information item.

The facility further enables information items and pinboard collections (e.g., any document) to be easily located without referencing a particular location. A user can provide some information relating to the information being sought, such as a URL, name, description, content, etc., and the facility quickly locates and retrieves the information, provided the user has sufficient permissions to view the information. The facility also enables the user to share the information with others when the user has sufficient permissions to do so.

In various embodiments, the facility provides an ability to determine backwards and forwards links in pinboard collections. As an example, the facility can determine which pinboard collections a particular information item is pinned to. The facility is able to determine these relationships based on a database the facility employs to track pinboard collections and information items.

In various embodiments, a background agent notifies creators or recipients of pinboard collections that information items matching queries used to create the pinboard collections have been modified or added. The creators or recipients can then optionally modify the pinboard collection to include the modified or added information item. In these embodiments, the background agent may perform stored queries intermittently. Alternatively, the background agent may receive events relating to changes to information items. The background agent may then notify creators, recipients, or both, such as by sending an e-mail message.

In various embodiments, the facility invokes various actions when it detects that an information item or ACPs relating to an information item or pinboard collection change. As an example, upon detecting that a pinboard collection is shared with a user belonging to a particular group of users, the facility invokes a workflow application that requires a managing user to approve the sharing. The facility is capable of detecting changes to content and ACPs using various means. As examples, the facility may register with an operating system to receive change notifications or may poll an operating system's change log. When it detects changes, the facility invokes workflow components that are registered with the facility.

In various embodiments, the facility builds one or more indices of information items, pinboard collections, and permissions. The indices enable the facility to find information items having a specified set of permissions. As an example, the indices enable the facility to find all information items that have been shared with a given user.

In various embodiments, the facility enables integration of searching with a document authoring canvas. In these embodiments, a user of an authoring application can perform a search using search providers outside the application's context and quickly and easily embed the results of the search within a document being authored with the application. Thus, for example, a user of a word processing document or spreadsheet can perform a search using a single action and add the results of the search to the document or spreadsheet that the user is authoring.

In various embodiments, the facility may be extended using replication. As an example, the facility may replicate pinboard collections and their underlying data to multiple servers, such as servers located in multiple Internet domains. When the pinboard collections and their underlying data are replicated, users of a domain do not need to access servers of another domain to share or receive pinboard collections.

In various embodiments, the facility discovers search providers automatically when searching using search criteria provided by a creator or recipient and, optionally, installs the search provider automatically. Information located using the search criteria identifies from where and how to install the search provider.

In various embodiments, the facility functions with a variety of types of documents that may be considered to be “containers.” A container is a document that contains other documents or references to other documents. Examples of containers include, e.g., media playlists, installation files containing other files and instructions for installing the other files on a computing system, and so forth. Because containers are similar to pinboard collections, the facility works with any type of container. A user can control access to files in the container by manipulating permissions on the container. As an example, when a user indicates that a recipient should have view access to a container, the facility also provides view access to all files contained or indicated by the container. Furthermore, when a container contains other containers, the facility may recursively apply the permissions to the files indicated by the contained containers. Furthermore, because the facility enables third parties to extend the facility by providing logic indicated by an information item that is contained by a container, the facility can automatically recognize additional file formats of files contained by containers. In various embodiments, the facility may enable a user to indicate specific information items from which a pinboard collection (e.g., a container) is to inherit permissions.

In various embodiments, the facility enables a user to create a “personal portal” based on information items and pinboard collections available to the user. As an example, the user may indicate that a pinboard collection is available for remote use. When a pinboard collection is enabled for remote use, the user can access the personal portal from a remote computing device in a manner similar to using MICROSOFT OUTLOOK WEB ACCESS to remotely access e-mail stored on a MICROSOFT EXCHANGE SERVER.

In various embodiments, the facility provides a generic model for generating relational indices based on documents. The relational indices, in conjunction with full text indices built by the search providers, enable the facility to generate and maintain data that is extracted from varying schemas that represent similar information. As an example, the facility builds a link index using information derived from any type of document that is a collection of links, such as dashboards, playlists, html files, deployment files, and so forth. The facility can employ the link index to create the back links and related links described above, such as by determining relationships of documents. This generic model can be also used to generate other custom indices, such as contact information tables or application setup tables. The contact information tables can be used, e.g., to populate a Lightweight Directory Access Protocol server or create a list of contacts based on shared documents. The application setup tables can be used, e.g., to create an application setup repository that an operating system feature can use to add or remove software programs.

In various embodiments, the facility combines the addressability of e-mail, navigational ease of an Internet browser, and simplicity of search to create collections of information that can be shared, updated, and utilized for collaboration. The collaboration can be initiated and controlled by defining access control permissions relating to information items.

As is evident from the description provided above, the facility enables a creator to build a pinboard collection (e.g., a portal) with searching as a primary navigation metaphor. Unlike conventional hosted systems, the facility enables the portal to exist with no entry point. That is, a recipient does not need the portal's location or even need to be aware that a particular portal exists to be able to view it. The facility creates and manages portals organically, in that information items and pinboard collections contained by the portal can be added, removed, or modified easily. Again unlike conventional hosted systems, an administrator is not required to indicate which users should have access and which users should not.

The facility also enables a concept known as a “share-box.” A share box contains one or more pinboard collections and enables its user to control what data from a pinboard collection is displayed, organized, or acted upon. A user can indicate that some pinboard collections should display information items while other pinboard collections should only be listed in a “collapsed” condition. The user would then be able to expand a collapsed pinboard collection to display its contents. A user can organize a share box by indicating areas that contain pinboard collections or information items having specified attributes. As an example, a share box can have an area that displays all pinboard collections shared during a specified timeframe, another area that displays pinboard collections shared with a particular user, and so forth. In some embodiments, the facility may employ an “AJAX” user interface design with share boxes. AJAX defines an architecture for defining user interfaces by making use of an AJAX engine that communicates with a server and dynamically updates a user interface. The user can take various actions on pinboard collections displayed in a share box. As examples, the user can respond to a shared pinboard collection, share a received or created pinboard collection with other users, remove a pinboard collection, indicate permissions for the pinboard collections, and so forth.

One skilled in the art can readily appreciate that the facility described above can be extended in various ways. As an example, the facility can create an index on various types of information contained in information items, such as contact information, and provide an API or user interface for accessing the data via an application or service (e.g., a shared contacts application or a Lightweight Directory Access Protocol server). In some embodiments, the facility is adaptable to provide a user interface for such an application.

In various embodiments, the facility employs a file system to store information items and other objects. In these embodiments, an underlying operating system notifies the facility when these information items or objects change (e.g., when they are modified, created, deleted, and so forth). The facility creates and manages an index associated with the information items and objects and, when it receives these notifications from the operating system, modifies the index accordingly. Other applications and services may employ the index and the underlying information items or objects. As an example, a messaging client program (e.g., MICROSOFT OUTLOOK) may be able to utilize files located in the file system to compose or review e-mail. By storing e-mail messages (or information items and objects, in general) in files, the facility enables offline use.

In various embodiments, the facility creates a single place to query for all information that is “shared” with a user. This enables the facility program to build new indices on the same shared data and expose application interfaces to retrieve the data in meaningful ways.

The facility may also be readily extended to create other application-specific “servers” for enterprises. As an example, the facility can create a software repository server, directory provider, and so forth. A software repository server would store various software applications, updates thereto, etc. When the user employs an operating system component to add or install a program, the facility could easily determine whether the user has sufficient ACPs to install the program or update and then provide the program or update to the operating system component for installation. An administrator (or other user with sufficient privileges) can share the application with the user needing the application or update. The directory provider may, e.g., store information relating to printers. An administrator or user can share a printer with a user needing access to a printer. When the user uses a component of the operating system to add a printer, the facility may provide an indication of the shared printer.

As a specific example, the facility can be employed during “staged” deployments of enterprise or business software. Suppose a container contains indications of files that are to be installed on users' computing devices. This container can be shared with classes of users (e.g., early adopters, late adopters, etc.) to stage the deployment of the software to these user classes.

A personalizable information network can alternatively be referred to as a personal information network or personalized information network.

While various embodiments are described in terms of the environment described above, those skilled in the art will appreciate that the facility may be implemented in a variety of other environments including a single, monolithic computer system, as well as various other combinations of computer systems or similar devices connected in various ways.

One skilled in the art will appreciate that the logic the flow diagrams illustrate and relating descriptions the specification describes may be altered in a variety of ways. For example, the order of the blocks may be rearranged, logic may be performed in parallel, some logic may be omitted, or other logic may be added, etc.

While some figures and their descriptions illustrate tables whose contents and organization are designed to make them more comprehensible by a human reader, those skilled in the art will appreciate that actual data structures used by the facility to store information may differ from the tables shown, for example in that they may be organized in a different manner, may contain more or less information than shown, may be compressed and/or encrypted, etc.

While user interfaces are illustrated with some user interface elements, those skilled in the art will appreciate that the user interface elements may be rearranged, additional user interface elements may be added, or user interface elements may be eliminated. Those skilled in the art will also appreciate that various user interface elements can be substituted for one another without materially affecting functionality of the facility.

Those skilled in the art will appreciate that the above-described facility may be straightforwardly adapted or extended in various ways. For example, the facility may employ various indexing or search providers. These indexing or search providers may operate on a user's desktop computer or on a remote computing device, such as a server. The facility can operate with various information types, such as documents, web logs (“blogs”), web pages, data from various sources, images, multimedia, and so forth. While the foregoing description makes reference to particular embodiments, the scope of the invention is defined solely by the claims that follow and the elements recited therein.

We claim:

1. A method performed by a computing device for creating a shareable pinboard collection, comprising:
receiving from a user a selection of one or more search providers, each of the search providers for searching an information source;
employing the selected one or more search providers to perform a search for information items matching a criteria specified by the user; and
receiving an indication of information items located by the selected one or more search providers, each located information item indicating a result.

2. The method of claim 1 including employing multiple search providers to concurrently perform a search for information items based on the query.

3. The method of claim 1 including transforming the result into an internal form.

4. The method of claim 3 wherein the internal form is RSS.

5. The method of claim 3 wherein the transforming includes creating an extract of the result.

6. The method of claim 1 wherein the receiving includes receiving an indication of a single action performed by a user.

7. The method of claim 1 wherein the employing includes retrieving information from the selected one or more search providers relating to how to employ the search provider.

8. The method of claim 1 wherein the information includes an application program interface.

9. The method of claim 1 wherein one of the search providers is a third-party search provider that is indicated in a shareable pinboard collection.

10. The method of claim 1 further comprising creating the pinboard collection comprising at least the indicated information items.

11. The method of claim 10 wherein the pinboard collection indicates links between the pinboard collection and the indicated information items.

12. The method of claim 11 further comprising storing a link associating the indicated information items with the pinboard collection.

13. The method of claim 12 further comprising retrieving other pinboard collections with which the indicated information items are associated.

14. The method of claim 1 further comprising dynamically adding a search provider that can be selected by the user.

15. The method of claim 1 further comprising filtering the information items.

16. A computer-readable medium having computer-executable instructions for performing a method of creating a shareable pinboard collection, the method comprising:
employing multiple search providers to perform a search for information items matching a criteria specified by a user;
merging results provided by the search providers into an internal form; and
providing an indication of the merged results to a user.

17. The computer-readable medium of claim 16 including transforming the merged results before providing the indication of the merged results to a user.

18. The computer-readable medium of claim 17 wherein the transforming includes creating an HTML document.

19. The computer-readable medium of claim 16 including receiving an indication to pin some of the merged results.

20. The computer-readable medium of claim 16 wherein the internal form is RSS.

21. The computer-readable medium of claim 16 including employing a provider description that is indicated by a search provider.

22. The computer-readable medium of claim 21 wherein the provider description is an application program interface.

23. The computer-readable medium of claim 16 wherein a merged result contains a back link wherein the back link is an indication of a previously stored pinboard collection that also contains one of the results.

24. The computer-readable medium of claim 16 wherein the merging includes overlaying a result wherein the overlaying includes combining results from multiple search providers and removing duplicate attributes to provide a single result that has unique attributes from some of the multiple search providers.

25. The computer-readable medium of claim 16 wherein a result indicates a search provider.

26. The computer-readable medium of claim 25 further comprising dynamically registering the search provider and employing the search provider to perform the search.

27. The computer-readable medium of claim 16 wherein at least two search providers provide different types of results, each type of result viewable using a different viewing component.

28. The computer-readable medium of claim 16 wherein the merged results are overlaid with results from a second search.

29. The computer-readable medium of claim 16 further comprising transforming the results from the internal form into a form that is provided to the user.

30. The computer-readable medium of claim 16 wherein a location is specified for an information item and wherein the location identifies a point within the information item.

31. The computer-readable medium of claim 30 wherein the location is specified using a bookmark anchor tag.

32. The computer-readable medium of claim 30 wherein the information item is pinned to a pinboard collection.

33. The computer-readable medium of claim 32 wherein the pinboard collection has an annotation associated with the pinned information item.

34. The computer-readable medium of claim 32 wherein another pinboard collection has an annotation relating to the pinned information item.
